(19) United States
(12) Patent Application Publication
(10) Pub. No.: US 2025/0297055 A1
(43) Pub. Date: Sep. 25, 2025

(54) METHOD FOR PREPARING AN EPOXY-DERIVED COVALENT ADAPTABLE NETWORK

(71) Applicant: Universiteit Gent, Gent (BE)

(72) Inventors: Filip van Lysebetten, Sint-Gillis-Waas (BE); Johan Winne, Melle (BE); Filip du Prez, Gent (BE)

(73) Assignee: Universiteit Gent, Gent (BE)

(21) Appl. No.: 18/869,295

(22) PCT Filed: Jun. 8, 2023
(86) PCT No.: PCT/EP2023/065326

§ 371 Date: Nov. 26, 2024

(30) Foreign Application Priority Data
Jun. 13, 2022 (EP) 22178661.9

(51) Int. Cl. C08G 59/58

(52) U.S. Cl. CPC C08G 59/58

(57) ABSTRACT

The invention relates to a method to prepare a composition comprising an epoxy-based covalent adaptable network.

The method comprises the steps of
a) contacting a compound A and a compound B in controlled amounts to obtain a mixture comprising a curing agent. The compound A has a′ functional groups of the type —C(═O)ORx and/or of the type —C(═O)— with the a′ functional groups being arranged in pairs, positioned at a controlled distance from each other. The compound B has b′ primary amine functional groups with the b′ primary amine functional groups being arranged in pairs, positioned at a controlled distances from each other.
b) contacting the mixture obtained in step a) with at least one compound C having epoxide functional groups to obtain the epoxy-derived covalent adaptable network.

The invention further relates to compositions obtainable by such method.

### FIELD OF THE INVENTION

The present invention relates to a method for preparing a composition comprising an epoxy-derived covalent adaptable network. Furthermore, the invention relates to compositions comprising an epoxy-derived covalent adaptable network.

### BACKGROUND ART

Epoxy based compositions are known in the art. Because of their excellent physical-mechanical properties and excellent corrosion resistance and abrasion resistance, epoxy-based compositions are widely used for example as coating.

Most epoxy based coatings are obtained by using polyfunctional amines such as aliphatic amines, polyamides and polyamidoamines as curing agent.

EP1024159 describes the use of polyamidoamine curing agents for curing epoxy resins. The epoxy curing agents comprise the reaction product of a mixture comprising a fatty monocarboxylic acid, an aromatic monocarboxylic acid, an aromatic dicarboxylic acid and a polyethylene amine, wherein the ratio of equivalents of fatty monocarboxylic acid to aromatic monocarboxylic acid ranges from about 1:0.2 to about 1:1.5, the ratio of equivalents of monocarboxylic acids to aromatic dicarboxylic acid ranges from about 1:0.1 to about 1:0.6, and the ratio of moles of total polyamine to equivalents of total acid can range from about 0.8:1 to about 1.3:1.

Although conventionally obtained cross-linked epoxy resins are widely used, they have some drawbacks. They can for example not be reshaped or reprocessed into high value products because of their permanent and irreversible cross-links. Consequently, the conventional epoxy resin cannot be recycled mechanically.

Recently, the incorporation of exchangeable covalent bonds brought interesting properties to conventional thermoset formulation, in particular to their (re) processing options and recyclability. Such networks comprising dynamic covalent bonds are often referred to as covalent adaptable networks (CANs).

Although the incorporation of dynamic covalent bonds in the epoxy network results in materials having interesting properties, the introduction of such dynamic covalent bonds may negatively influence the properties of the material as for example the thermal and dimensional stability of the material. Therefore, the incorporation of dynamic covalent bonds to obtain an epoxy network remains challenging. Moreover, achieving thermally induced material flow is often limited to specific polymer networks that consist of specific monomers, monomer ratios or catalysts, that limit their application. For example, epoxide monomers have been combined with transesterification (e.g. Leibler and co-workers, Science, 2011, 334 (6058) 965-968), transamination (e.g. Du Prez and co-workers, Macromolecules, 2020, 53 (7) 2485-2495), disulfide metathesis (e.g. Odriozola and co-workers, Mater. Horizons, 2016, 3 (3) 241-247) and imine exchange (e.g. Wu and co-workers, Chemical Engineering Journal, 2019, 368 61-70) chemistries to obtain epoxy-derived covalent adaptable networks.

### SUMMARY OF THE INVENTION

It is an object of the present invention to provide a method for preparing curing agents for compositions comprising an epoxy-derived covalent adaptable network and for preparing compositions comprising an epoxy-derived covalent adaptable network not displaying the drawbacks of the compositions known in the art.

It is another object of the present invention to provide a method for preparing compositions comprising an epoxy-derived covalent adaptable network having a good thermal stability (>200° C.) allowing (re) processability at high temperatures (200-300° C.).

It is another object of the present invention to provide a method for preparing curing agents for compositions comprising an epoxy-derived covalent adaptable network and for preparing compositions comprising an epoxy-derived covalent adaptable network suitable for use in processing techniques as for example in additive manufacturing, casting, extrusion, injection moulding, compression moulding, transfer moulding, foam moulding, thermoforming and rotation moulding.

It is also a further object of the present invention to provide a method to apply an adhesive or coating comprising an epoxy-derived covalent adaptable network on a substrate.

It is an object of the present invention to provide a method to apply an encapsulation comprising an epoxy-derived covalent adaptable network on electronic components.

It is still a further object of the present invention to provide compositions comprising an epoxy-derived covalent adaptable network having a good recyclability.

Furthermore it is an object of the present invention to provide compositions suitable as (structural) adhesive, as (fusion bonded) epoxy coating or in composites such as fiber-reinforced composites.

According to a first aspect of the present invention, a method for preparing a composition comprising an epoxy-based covalent adaptable network is provided. The method comprises the steps of
a) contacting at least one compound A with at least one compound B, hereby obtaining a mixture comprising or consisting of a curing agent, with the at least one compound A having a′ functional groups of the type —C(═O)ORx and/or of the type —C(═O)—, with a′ being an integer equal or greater than 2 and with Rx for each a′ functional group being independently selected from the group consisting of H and C1-C4 alkyls.

Each of the a′ functional groups of the type —C(═O)ORx and/or of the type —C(═O)—belong to a pair of functional groups comprising a first functional group and a second functional group, whereby the number of atoms between the carbonyl group of the first functional group and the carbonyl group of the second functional group ranges between 2 and 8. The at least one compound B has b′ primary amine functional groups, with b′ being an integer equal or greater than 2, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom.

During step a) dynamic bonds are formed by reaction of at least part of the a′ functional groups of the type —C(═O)ORx and/or of the type —C(═O)— with at least part of the b′ primary amine functional groups.
b) contacting the mixture obtained in step a) with at least one compound C, hereby obtaining an epoxy-derived covalent adaptable network, with the at least one compound C having c′ epoxide functional groups, with c′ being an integer equal or greater than 2.

During step b) permanent (non-dynamic) bonds are formed by reaction of at least part of the least c′ epoxide functional groups with an active hydrogen atom of a functional group capable of reacting with an epoxide functional group present in the mixture.

The following requirements are met
Σnⱼ bⱼ′; is equal or greater than Σnⱼ a′ᵢ,
the ratio

$$\frac{\sum {n}_{k} {c}_{k}^{′}}{x}$$

ranges between 0.5 and 1.5, and
the ratio

$$\frac{\sum {n}_{i} {a}_{i}^{′}}{\sum {n}_{i} {a}_{i}^{′} + x}$$

is equal or greater than 0.4 in case x≥Σnₖc′k or the ratio

$$\frac{\sum {n}_{i} {a}_{i}^{′}}{\sum {n}_{i} {a}_{i}^{′} + \sum {n}_{k} {c}_{k}^{′}}$$

is equal or greater than 0.4 in case x<Σnₖc′k
with
nᵢ being the number of mmol (millimoles) of compound Aᵢ with functionality a′ᵢ,
nⱼ being the number of mmol (millimoles) of compound Bⱼ with functionality b′ⱼ,
nₖ being the number of mmol (millimoles) of compound Cᵢ with functionality c′ₖ,
x being the total number of active hydrogen atoms of all functional groups capable of reacting with an epoxide functional group present at the start of step b).

In case the at least one compound A comprises a pair of functional groups having a functional group of the type —(C═O)— as first and as second functional group, the at least one compound A comprises a cyclic carboxylic acid anhydride with the first and the second functional groups belonging to the carboxylic acid functional group of the at least one compound A.

In preferred embodiment, the at least one compound A has a′ functional groups of the type —C(═O)ORx with each of the a′ functional groups of the type —C(═O)ORx belonging to a pair of functional groups comprising a first functional group and a second functional group.

For the sake of completeness a′ᵢ refers to the number of a′ functional groups of the type-C(═O)ORx and/or of the type —C(═O)— of compound Aᵢ (A₁, A₂, A₃, . . . ). b′ⱼ refers to the number of b′ primary amine functional groups of compound Bⱼ (B₁, B₂, B₃, . . . ). c′ₖ refers to the number of c′ epoxide functional groups of compound Cₖ (C₁, C₂, C₃, . . . ).

For the purpose of this invention, Σnⱼ a′ᵢ can be referred to as the combined molar amount of a′ functional groups of the type —C(═O)ORx and/or of the type —C(═O)— of all compounds A at the start of step a). In case two different compounds A (A₁ and A₂) are present at the start of step a), the combined molar amount of b′ primary amine functional groups of all compounds A can be written as

$$\sum {n}_{i} {a}_{i}^{′} = {n}_{1} {a}_{1}^{′} + {n}_{2} {a}_{2}^{′}$$

with nᵢ being the number of mmol (millimoles) of compound Aᵢ with functionality a′ᵢ,
n₁ being the number of mmol (millimoles) of compound A₁ with functionality a′1,
n₂ being the number of mmol (millimoles) of compound A₂ with functionality a′2.

Similarly, Σnⱼ b′ⱼ can be referred to as the combined molar amount of b′ primary amine functional groups of all compounds B at the start of step a). In case two different compounds B (B₁ and B₂) are present at the start of step a), the combined molar amount of b′ primary amine functional groups of all compounds B can be written as

$$\sum {n}_{i} {b}_{j}^{′} = {n}_{1} {b}_{1}^{′} + {n}_{2} {b}_{2}^{′}$$

with nⱼ being the number of mmol (millimoles) of compound Bⱼ with functionality b′ⱼ,
n₁ being the number of mmol (millimoles) of compound B₁ with functionality b′1, and
n₂ being the number of mmol (millimoles) of compound B₂ with functionality b′2.

Similarly, Σnk c′ₖ can be referred to as the combined molar amount of c′ epoxide functional groups of all compounds C at the start of step b). In case two different compounds C (C1 and C2) are present at the start of step b), the combined molar amount of c′ epoxide functional groups of all compounds C can be written as

$$\sum {n}_{k} {c}_{k}^{′} = {n}_{1} {c}_{1}^{′} + {n}_{2} {c}_{2}^{′}$$

with nₖ being the number of mmol (millimoles) of compound Cⱼ with functionality c′ⱼ,
n₁ being the number of mmol (millimoles) of compound C₁ with functionality c′1, and
n₂ being the number of mmol (millimoles) of compound C₂ with functionality c′2.

The total number of active hydrogen atoms of a functional group capable of reacting with an epoxide functional group is defined as x. The total number of active hydrogen atoms present at the start of step b) is explained further in more detail.

Although it is generally accepted that the incorporation of dynamic covalent bonds in a network such as an epoxy network negatively influences properties such as the thermal and dimensional stability, it has surprisingly been found that by using the start compounds A, B, C in amounts as specified above, an epoxy-based covalent adaptable network having good thermal and dimensional stability properties is obtained. Moreover, it is important that the (maximum) amount of dynamic bonds over the (maximum) number of dynamic and permanent (non-dynamic) bonds is controlled.

As dynamic bonds are formed in step a) by reaction of a′ functional groups of the type —C(═O)ORx and/or of the type —C(═O)— of the at least one compound A with b′ primary amine functional groups of the at least one compound B, and the combined molar amount of b′ primary amine functional groups of all compounds B at the start of step a) (Σnⱼ b′ⱼ) is equal or greater than the combined molar amount of a′ functional groups of the type —C(═O)ORx and/or of the type-C(═O)— of all compounds at the start of step a) (Σnᵢ a′ᵢ), the maximum number of dynamic bonds is determined by the number of a′ functional groups of the type —C(═O)ORx and/or of the type —C(═O)—.

Preferably, the combined molar amount of b′ primary amine functional groups of all compounds B at the start of step a) (Σnⱼ b′ⱼ)) is greater than the combined molar amount of a′ functional groups of the type —C(═O)ORx and/or of the type —C(═O)— of all compounds A at the start of step a) (Σnᵢ a′ᵢ). The combined molar amount of b′ primary amine functional groups of the at least one compound B at the start of step a) (2 n; b′ⱼ) is for example 5%, 10%, 20%, 30% or 50% greater than the combined molar amount of a′ functional groups of the type —C(═O)ORx and/or of the type —C(═O)—at the start of step a) (Σn; a′ⱼ).

Preferably, all or substantially all of the a′ functional groups of the type —C(═O)ORx and/or of the type —C(═O)—react with a b′ primary amine functional groups of the at least one compound B. In case all a′ functional groups of the type —C(═O)ORx and/or of the type —C(═O)—react with a b′ primary amine functional groups of the at least one compound B, the combined molar amount of dynamic bonds is equal to Σnᵢ aᵢ′ (the combined molar amount of a′ functional groups of the type —C(═O)ORx and/or of the type —C(═O)— of all compounds A at the start of step a)). Preferably, the combined molar amount of dynamic bonds is at least 80% of Σnⱼ a′ᵢ, at least 85% of Σnᵢ a′ᵢ, at least 90% of Σnᵢ a′ᵢ or at least 95% of Σnᵢ a′ᵢ.

As the combined molar amount of b′ primary amine functional groups of the at least one compound B at the start of step a) (Σn, b′ⱼ) is preferably greater than the combined molar amount of a′ functional groups of the type —C(═O) OR and/or of the type —C(═O)— of the at least one compound A at the start of step a) (Σn; a′ⱼ), after reaction of the a′ functional groups with the b′ primary amine functional groups an excess number of unreacted b′ primary amine functional groups preferably remains. Such excess b′ primary amine functional groups can for example react in step b) of the method according to the present invention.

Permanent bonds are formed in step b) by reaction of at least part of c′ epoxide functional groups of the at least one compound C with an active hydrogen atom of a functional group capable of reacting with an epoxide functional group.

According to the present invention the ratio

$$\frac{\sum {n}_{k} {c}_{k}^{′}}{x}$$

ranges between 0.5 and 1.5. More preferably, the ratio

$$\frac{\sum {n}_{k} {c}_{k}^{′}}{x}$$

ranges between 0.7 and 1.3, for example between 0.8 and 1.2. Most preferably, the ratio

$$\frac{\sum {n}_{k} {c}_{k}^{′}}{x}$$

ranges between 0.9 and 1.1 and is for example 0.95, 1 or 1.05.

The maximum number of permanent bonds that can be formed is either determined by the total number of c′ epoxide functional group present in the mixture at the start of step b) or by the total number of an active hydrogen atoms of all functional group capable of reacting with an epoxide functional group present in the mixture at the start of step b), depending which one is the highest.

According to the present invention, in case x≥Σnₖc′ₖ then the ratio

$$\frac{\sum {n}_{i} {a}_{i}^{′}}{\sum {n}_{i} {a}_{i}^{′} + x}$$

has to be equal or greater than 0.4. In case x<Σnₖ c′ₖ, then the ratio

$$\frac{\sum {n}_{i} {a}_{i}^{′}}{\sum {n}_{i} {a}_{i}^{′} + \sum {n}_{k} {c}_{k}^{′}}$$

is equal or greater than 0.4.

In preferred embodiments of the present invention the ratio

$$\frac{\sum {n}_{i} {a}_{i}^{′}}{\sum {n}_{i} {a}_{i}^{′} + x} ,$$

respectively the ratio

$$\frac{\sum {n}_{i} {a}_{i}^{′}}{\sum {n}_{i} {a}_{i}^{′} + \sum {n}_{k} {c}_{k}^{′}}$$

is equal or greater than 0.5, equal or greater than 0.6 or equal or greater than 0.8.

Optionally, one or more additional compounds can be present in step a) of the method according to the present invention. In preferred embodiments, at least one compound E is present in step a) of the method. In such case compound step a) comprises contacting at least one compound A, at least one compound B and at least one compound E to obtain a mixture comprising or consisting of a curing agent. The at least one compound E comprises e′ primary amine functional groups (with e′ an integer equal or greater than 1) and does not comprise a pair of functional groups comprising a first primary amine functional group and a second primary amine functional groups, whereby the number of atoms between the first primary amine functional group and the second primary amine functional group is at least 5. Preferred compounds E comprise one e′ primary amine functional group. In case compound E comprises more than one e′ primary amine functional groups, these primary amine functional groups can be the same or can be different.

It is clear that compound E may comprise additional functional groups (other than the e′ primary functional groups). Such additional functional groups are referred to as e″ additional functional groups.

The main function of compound E is to influence the viscosity of the mixture obtainable in step a) of the method according to the present invention, preferably to decrease the viscosity of the mixture obtainable in step a).

Preferably, the amount of the at least one compound E is limited, for example limited to maximum 10 wt % of the total amount of the at least one compound B or limited to maximum 5 wt % of the total amount of the at least one compound B.

Alternatively or additionally, an active hydrogen atom may comprise a hydrogen atom of a functional group of at least one additional compound present in the mixture at the start of step b). Such additional compound is referred to as at least one compound D having one or more d′ additional functional groups. In case compound D has more than one d′ additional functional groups, these additional functional groups can be the same or can be different. In preferred embodiments of the present invention the at least one compound D has two or more d′ additional functional groups.

The at least one compound D may function as a cross-linking agent.

Preferably, the amount of the at least one compound D is limited to maximum 10 wt % of the mixture.

Active Hydrogen Atom of a Functional Group Capable of Reacting with an Epoxide Functional Group

For the purpose of this invention, any hydrogen atom of a functional group that is capable of reacting with an epoxide functional group present can be considered as an active hydrogen atom.

Within the context of this invention, the terms active hydrogen atom and active hydrogen are used interchangeably.

A functional group capable of reacting with an epoxide functional group preferably comprises a functional group selected from the group consisting of primary amine functional groups, secondary amine functional groups, alcohol functional groups, thiol functional groups and —C(═O) OH functional groups.

A functional group capable of reacting with an epoxide functional group may comprise one or more active hydrogen atoms. Secondary amine functional groups, alcohol functional groups, thiol functional groups and —C(═O) OH functional groups have one active hydrogen atom. Primary amine functional groups have two active hydrogen atoms.

As mentioned above, the total number of all active hydrogen atoms (=the sum of all active hydrogen atoms) present at the start of step b) is referred to as x. Active hydrogen atoms at the start of step b) comprise amongst others active hydrogen atoms of compound B and/or active hydrogen atoms of compound E and/or active hydrogen atoms of compound D.

An active hydrogen atom at the start of step b) of a compound B may comprise a hydrogen atom of a functional group of the at least one compound B, either of a b′ primary amine functional group that has not reacted with an a′ functional group of the type —C(═O)ORx and/or of the type —C(═O)— of the at least one compound A or a hydrogen atom of an additional functional group of compound B (other than a b′ primary amine functional group). Such an additional functional group of the at least one compound B is hereby referred to as a b″ additional functional group. It is clear that a compound B may have one or more b″ additional functional groups. In case compound B has more than one b″ additional functional groups, these additional functional groups can be the same or can be different.

An active hydrogen atom present at the start of step b) of a compound E may comprise a hydrogen atom of an e′ primary amine functional group either of an e′ primary amine functional group that has not reacted with an a′ functional group of the type —C(═O)ORx and/or of the type-C(═O)— of the at least one compound A or a hydrogen atom of an additional functional group of compound E (other than an e′ primary amine functional group), referred to as e″ additional functional group.

An active hydrogen atom present at the start of step b) of a compound D may comprise a hydrogen atom of a d′ additional functional group.

It is clear that the at least one compound A may comprise more than one compound A, for example a mixture of compounds An, such as a mixture of a compound A1, a compound A2 and a compound A3.

Similarly, the at least one compound B may comprise more than one compound B, for example a mixture of compounds Bn, such as a mixture of a compound B1, a compound B2 and a compound B3.

In case the mixture at the start of step b) also comprises at least one compound D, the at least one compound D may comprise more than one compound D for example a mixture of compounds Dn, for example a mixture of a compound D1, a compound D1 and a compound D3.

In case the mixture at the start of step a) also comprises at least one compound E, the at least one compound E may comprise more than one compound E for example a mixture of compounds En, for example a mixture of a compound E1, a compound E1 and a compound E3.

### Compound A

As mentioned above, the at least one compound A has a number of a′ functional groups of the type —C(═O)ORx and/or of the type —C(═O)— with a′ being an integer equal or greater than 2, for example 2, 3, 4 or 5 and with Rx of each functional group being independently selected from the group consisting of H and C1-C4 alkyls. Rx of each of the functional groups comprises preferably H, methyl or ethyl.

In case the at least one compound A comprises a pair of functional groups having a functional group of the type —(C═O)— as first and as second functional group, the at least one compound A comprises a cyclic carboxylic acid anhydride with the first and the second functional groups belonging to the carboxylic acid functional group of the at least one compound A.

It is clear that the at least one compound A may also comprise a combination of a′ functional groups of the type —C(═O)ORx and of the type —C(═O)—.

Preferred compounds A comprise a′ functional groups of the type —C(═O)ORx, with a′ being an integer equal or greater than 2, for example 2, 3, 4 or 5 and with Rx of each functional group being independently selected from the group consisting of H and C1-C4 alkyls. Rx of each of the functional groups comprise preferably H, methyl or ethyl.

For compound A, the number of atoms between the carbonyl group of the first functional group and of the second functional group of a pair of functional groups of the type —C(═O)ORx and/or of the type —C(═O)—ranges between 2 and 8. Preferably, the number of atoms between the carbonyl group of the first functional group and the carbonyl group of the second functional group of a pair of functional groups of the type —C(═O)ORx and/or of the type —C(═O)— is 2, 3 or 4.

The atoms between the carbonyl group of the first functional group and the carbonyl group of the second functional group of a pair of functional groups of the type —C(═O)ORx and/or of the type —C(═O)— may comprise carbon atoms, either substituted or non-substituted or a combination of carbon atoms and one or more heteroatoms as for example one or more nitrogen atoms and/or one or more oxygen atoms. Preferably, the atoms between the carbonyl group of the first functional group and the carbonyl group of the second functional group of a pair of functional groups of the type —C(═O)ORx or of the type —C(═O)—comprise maximum one heteroatom, for example one oxygen atom or one nitrogen atom.

In case compound A comprises a cyclic structure and in case there is more than one connection between the carbonyl group of a first functional group and the carbonyl group of a second functional group of a pair of functional groups, in particular functional groups of the type —C(═O)ORx, at least one of these connections have 2 to 8 atoms. Preferably, the shortest connection of the plurality of connections between the carbonyl group of the first functional group and the carbonyl group of the second functional group of a pair of functional groups, in particular functional groups of the type —C(═O)ORx, has 2 to 8 atoms, more preferably 2, 3 or 4 atoms and even more preferably 2, 3 or 4 carbon atoms.

In case the first functional group and the second functional group of a pair of functional groups comprises a′ functional groups of the type —C(═O)ORx and in case there is more than one connection between the carbonyl group of the first functional group of the type —C(═O)ORx and the carbonyl group of the second functional of the type —C(═O)ORx, the number of atoms of the connection not including the oxygen positioned between the carbon atom and the Rx-group of the a′ functional groups is preferably ranging between 2 and 8. More preferably, the number of atoms of the connection not including the oxygen positioned between the carbon atom and the Rx-group of the a′ functional groups is 2, 3 or 4.

In preferred embodiments, the atoms between the carbonyl group of the first functional group of the type —C(═O)ORx and/or of the type —C(═O)—and the carbonyl group of the second functional group of the type —C(═O)ORx and/or of the type —C(═O)—comprise a linear saturated or unsaturated hydrocarbon, optionally comprising one or more heteroatom. One or more of the carbon atoms can be substituted, for example with a functional group selected from the group consisting of alkyl functional groups for example C1-C4 alkyls and alcohol functional groups.

Preferred linking moieties between the carbonyl group of first and second functional group of a pair of a′ functional groups comprise —CH₂—, —CH₂—CH₂—, —CH₂—CH₂—CH₂—, —CH₂—CH₂—CH₂—CH₂—, —CH₂—N —CH₂—, —CH₂—N —CH₂—CH₂—, —CH₂—O—CH₂—, . . .

Preferred compounds A comprise a′ functional groups of the type —C(═O)ORx. Examples of such compounds A comprise dicarboxylic acids such as succinic acid, glutaric acid, adipic acids, pimelic acid, suberic acid, azelaic acid and sebacic acid.

Other preferred compounds A comprising a′ functional groups of the type C(═O)ORx comprise monomethyl succinate, monomethyl glutarate, monomethyl adipate, monomethyl pimelate, monomethyl suberate, monomethyl azealate, monomethyl sebacate, dimethyl succinate, dimethyl glutarate, dimethyl adipate, dimethyl pimelate, dimethyl suberate, dimethyl azealate, di methyl sebacate.

Some further examples of preferred compounds A comprising a′ functional groups of the type —C(═O)ORx comprise

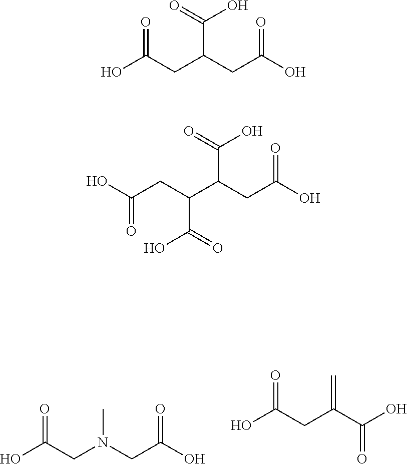

In further embodiments, at least part of the atoms between the carbonyl group of the first functional group and the carbonyl group of the second carbonyl group of a pair of functional groups of the type —C(═O)ORx is part of a cyclic structure. The cyclic structure can be substituted with one or more groups, for example with an alkyl group, an alcohol functional group and/or with an amine functional group.

The cyclic structure may comprise an aromatic or non-aromatic structure. The cyclic structure may comprise carbocyclic compounds or heterocyclic compounds, for example a cyclic structure comprising one or more heteroatom such as oxygen or nitrogen. The cyclic structure comprises preferably a monocyclic structure.

Preferred cyclic structures comprise 6-membered ring structures, either aromatic or non-aromatic, either substituted or non-substituted.

Particular examples comprise dimethyl phthalate and dimethyl cyclohexane-1,2-dicarboxylate. Other preferred examples are given below:

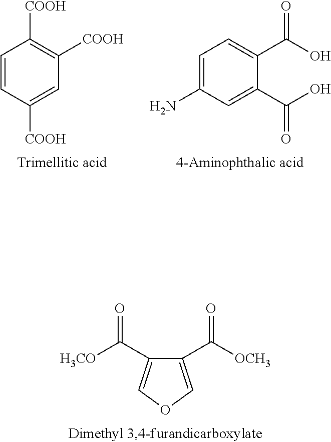 [SMILES: O=C(O)c1ccc(C(=O)O)c(C(=O)O)c1 ; Nc1ccc(C(=O)O)c(C(=O)O)c1 ; COC(=O)c1cocc1C(=O)OC]

In case compound A comprise a cyclic carboxylic acid anhydride, succinic anhydride, glutaric anhydride and adipic anhydride are preferred.

It is clear that the at least one compound A may further comprise other functional groups than the a′ functional groups of the type —C(═O)ORx and/or of the type —C(═O)—, as for example one or more amine functional group, one or more alcohol functional groups, one or more thiol functional groups and/or one or more-C(═O) ORy functional groups, with Ry being selected from the group consisting of H and C1-C4 alkyls, preferably methyl or ethyl.

For the sake of completeness, a functional group of the type —C(═O)ORx and/or of the type —C(═O)—that is not belonging to a pair of functional groups of the type —C(═O)ORx as specified above is not considered as an a′ functional group but as an additional functional group.

### Compound B

As mentioned above, the at least one compound B has a number of b′ primary amine functional groups. Optionally, the at least one compound B further comprises b″ additional functional groups. b′ is an integer equal or greater than 2, for example 2, 3, 4 or 5 and b″ is an integer equal or greater than 0, for example 0, 1, 2, 3 or 5.

Each of the b′ primary amine functional groups belongs to a pair of functional groups comprising a first primary amine functional group and a second primary amine functional group.

The number of atoms between the first primary amine functional group and the second primary amine functional group is at least 5. Each of the b′ primary amine functional groups is preferably directly connected to a primary carbon atom.

The atoms between the first primary amine functional group and the second primary amine functional group may comprise carbon atoms, either substituted or non-substituted or a combination of carbon atoms and one or more heteroatoms as for example one or more nitrogen atoms and/or one or more oxygen atoms. Preferably, the atoms between the first primary amine functional group and the second primary amine functional group comprise maximum one heteroatom, for example one oxygen atom or one nitrogen atom.

For preferred compounds B the number of atoms between the first primary amine functional group and the second primary amine functional group is at least 6, at least 8, at least 10, at least 12, at least 18 or at least 24.

In case compound B comprises a cyclic structure and in case there is more than one connection between the first amine functional group and the second amine functional group of a pair of amine functional groups, at least one of these connections comprises at least 5 atoms, more preferably at least 6, at least 8, at least 10, at least 12, at least 18 or at least 24 atoms, for example at least 5, at least 6, at least 8, at least 10, at least 12, at least 18 or at least 24 carbon atoms.

Preferably, the shortest connection, i.e. the connection having the lowest number of atoms, of the plurality of connections between the first amine functional group and the second amine functional group of a pair of amine functional groups has at least 5 and more preferably at least 6, at least 8, at least 10, at least 12, at least 18 or at least 24 atoms 2 to 8 atoms, for example at least , at least 6, at least 8, at least 10, at least 12, at least 18 or at least 24 carbon atoms.

In preferred embodiments, the moiety linking the first primary amine functional group and the second primary amine functional groups comprises or consists of a group selected from the group consisting of C₆₋₄₀alkyl, C₆₋₄₀alkenyl, C₆₋₄₀alkynyl, C₆₋₂₄aryl, C₆₋₂₄cycloalkyl, C₆₋₂₄aryIC1—40alkyl; wherein one or more of the carbon atoms in the backbone of said alkyl, alkenyl, alkynyl, aryl or cycloalkyl may be replaced by a heteroatom independently selected from O, S, N and Si; wherein said alkyl, alkenyl, alkynyl, aryl or cycloalkyl may be unsubstituted or further substituted.

In preferred embodiment, the at least one compound B comprises a fatty amine comprising at least 2 primary amine functional groups belongs to a pair of functional groups comprising a first primary amine functional group and a second primary amine functional group.

Fatty amines, as utilized herein, refers generally to the product of the Nitrile Process obtained from the polymerization of unsaturated fatty acids. The Nitrile process includes reaction of a fatty acid and ammonia at high temperature (>250° C.) in the presence of a metal oxide catalyst to obtain the nitrile compound, which upon hydrogenation delivers the desired amine monomer. The obtained fatty amines comprise a mixture of linear hydrocarbon chains and cyclic structures with 18 or more carbon atoms. More preferably a fatty amine comprises at least 22 or at least 36 carbon atoms. Preferred examples of fatty amines comprise the amine derivatives of tall oil fatty acid, stearic fatty acid, palmitic fatty acid, soya fatty acid, cottonseed fatty acid, oleic fatty acid and linoleic fatty acid.

The b″ additional functional groups comprise functional groups capable of reacting with an epoxide functional group and comprising at least one active hydrogen atom.

Examples of b″ additional functional groups comprise primary amine functional groups, secondary amine functional groups, alcohol functional groups, thiol functional groups and —C(═O) OH functional groups.

For the sake of completeness, a primary amine functional group that is not belonging to a pair of amine functional groups as specified above is not considered as a b′ functional group but as a b″ additional functional group.

Examples of suitable compounds B are given in the Table 1.

TABLE 1

| Name | CAS-number | Structure |
|---|---|---|
| Triethylenetetramine | 112-24-3 | 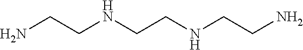 |
| Tetraethylene pentamine | 112-57-2 | 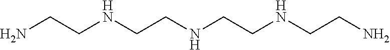 [SMILES: NCCNCCNCCNCCN] |
| Isophoronediamine | 2855-13-2 | 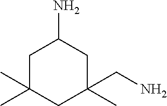 |
| 1,3- Bis(Aminomethyl)cyclohexane | 2579-20-6 | 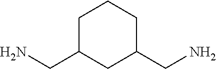 |
| m-xylenediamine | 1477-55-0 | 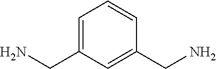 |
| 2-2′- (Ethylenedioxy)bis(ethylamine) | 929-59-9 | 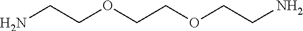 |
| Priamine 1074 | | 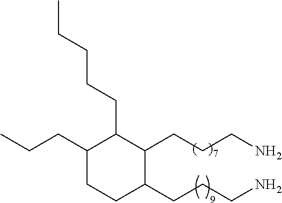 |
| 2,2,4-Trimethylhexane-1,6-diamine | 25513-64-8 | 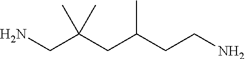 |

Other suitable compounds B comprise 4,7-dioxadecane-1,10-diamine, Diethylene Glycol Bis(3-aminopropyl) Ether, Jeffamine D230 and D400, Jeffamine XTJ-504 and XTJ-511, pentaethylenehexamine (PEHA), hexamethylenediamine (HMDA), N-(2-aminoethyl)-1,3-propanediamine, N,N′-bis(3-aminopropyl)ethylenediamine and 3,9-bis(3-aminopropyl) 2,4,8,10-tetraoxaspiro(5,5) undecane.

### Compound C

The at least one compound C comprises c′ epoxide functional groups, with c′ being an integer equal or greater than 2. Two c′ epoxide functional groups are connected by an epoxide linking moiety. Each of the epoxide linking moiety of compound C can be chosen independently. Preferably, an epoxide linking moiety comprises or consists of a group selected from the group consisting of C₁₋₄₀alkyl, C₂₋₄₀alkenyl, C₂₋₄₀alkynyl, C₅₋₂₄aryl, C₃₋₂₄cycloalkyl, C₆₋₂₄arylC₁₋₄₀alkyl; wherein one or more of the carbon atoms in the backbone of said alkyl, alkenyl, alkynyl, aryl or cycloalkyl may be replaced by a heteroatom independently selected from O, S, N and Si; wherein the alkyl, alkenyl, alkynyl, aryl or cycloalkyl may be unsubstituted or further substituted.

Examples of suitable compounds of formula (VII) are given in Table 2.

TABLE 2

| Name | CAS-number | Structure |
|---|---|---|
| Tris(4- hydroxyphenyl)methane triglycidyl ether | 66072-38-6 | 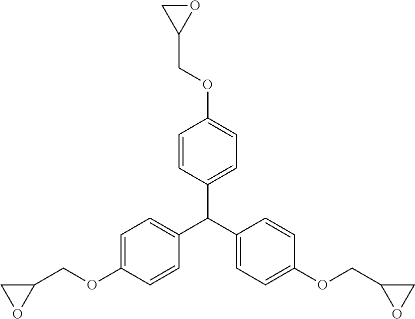 [SMILES: c1cc(C(c2ccc(OCC3CO3)cc2)c2ccc(OCC3CO3)cc2)ccc1OCC1CO1] |
| Trimethylolpropane triglycidyl ether | 3454-29-3 | 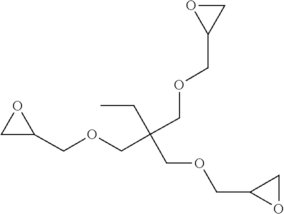 [SMILES: CCC(COCC1CO1)(COCC1CO1)COCC1CO1] |
| Bisphenol A diglycidyl ether | 1675-54-3 | 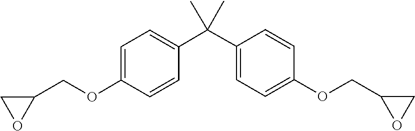 [SMILES: CC(C)(c1ccc(OCC2CO2)cc1)c1ccc(OCC2CO2)cc1] |
| 1,6-Hexanediol diglycidyl ether | 16096-31-4 | 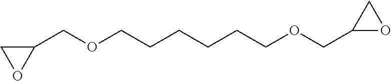 [SMILES: C(CCCOCC1CO1)CCOCC1CO1] |
| 1,4-Butanediol diglycidyl ether | 2425-79-8 | 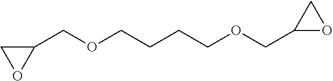 [SMILES: C(CCOCC1CO1)COCC1CO1] |
| Triglycidylisocyanuraat | 2451-62-9 | 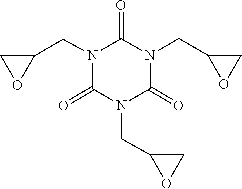 [SMILES: O=c1n(CC2CO2)c(=O)n(CC2CO2)c(=O)n1CC1CO1] |
| Hydrogenated bisphenol A diglycidyl ether | 13410-58-7 | 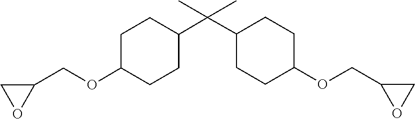 [SMILES: CC(C)(C1CCC(OCC2CO2)CC1)C1CCC(OCC2CO2)CC1] |
| 1,6-Naphthalenediol diglycidyl ether | 27610-48-6 | 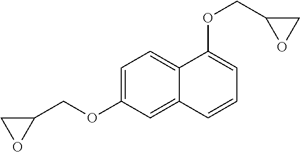 [SMILES: c1cc(OCC2CO2)c2ccc(OCC3CO3)cc2c1] |
| Neopentyl glycol diglycidyl ether | 17557-23-2 | 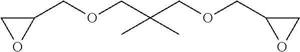 |
| Poly(propylene glycol) diglycidyl ether | 26142-30-3 | 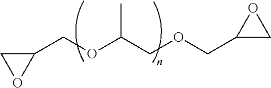 |
| 4,4'-Methylenebis(N,N- diglycidylaniline) | 28768-32-3 | 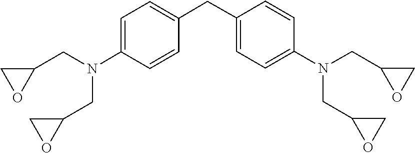 [SMILES: c1cc(N(CC2CO2)CC2CO2)ccc1Cc1ccc(N(CC2CO2)CC2CO2)cc1] |
| N,N-diglycidyl-4- glycidyloxyanilne | 5026-74-4 | 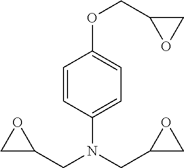 [SMILES: c1cc(N(CC2CO2)CC2CO2)ccc1OCC1CO1] |

Hence, in preferred embodiments the method described herein is provided wherein the at least one compound C is a compound selected from the group consisting of diglycidyl ethers, triglycidyl ethers, diglycidyl amines, triglycidyl amines, diglycidyl isocyanurates and triglycidyl isocyanurates, more preferably a compound selected from the group consisting of Tris(4-hydroxyphenyl) methane triglycidyl ether; Trimethylolpropane triglycidyl ether; Bisphenol A diglycidyl ether; Bisphenol F diglycidyl ether; Bisphenol C diglycidyl ether; Bisphenol E diglycidyl ether; Bisphenol BP diglycidyl ether; Bisphenol FC diglycidyl ether; Bisphenol Z diglycidyl ether; 1,6-Hexanediol diglycidyl ether; 1,4-Butanediol diglycidyl ether; Triglycidylisocyanuraat; Hydrogenated Bisphenol A diglycidyl ether; Hydrogenated Bisphenol F diglycidyl ether; Hydrogenated Bisphenol C diglycidyl ether; Hydrogenated Bisphenol E diglycidyl ether; Hydrogenated Bisphenol BP diglycidyl ether; Hydrogenated Bisphenol FC diglycidyl ether; Hydrogenated Bisphenol Z diglycidyl ether; 1,6-Naphthalenediol diglycidyl ether; Neopentyl glycol diglycidyl ether; Poly(propylene glycol) diglycidyl ether; 4,4′-Methylenebis(N,N-diglycidylaniline); and N,N-diglycidyl-4-glycidyloxyaniline.

In particular embodiments of the present invention, the at least one compound C is an epoxidized polydiene or a co-polymer thereof, an epoxidized vegetable oil or a co-polymer thereof or an epoxidized terpene or a co-polymer thereof, preferably an epoxidized cycloterpene, most preferably an epoxidized cyclic monoterpene. Preferred epoxidized polydienes are epoxidized natural rubbers, epoxidized poly(1,4-butadiene) and epoxidized styrene-butadiene rubber. Preferred epoxidized vegetable oils are epoxidized soy bean oil, epoxidized castor oil, epoxidized sunflower oil and epoxidized linseed oil. Preferred epoxidized terpenes are epoxidized limonene, epoxidized terpineol, epoxidized humulene, epoxidized myrcene. epoxidized linalool, epoxidized citronellol and epoxidized pinene.

It is clear that the at least one compound C may comprise other functional groups than the c′ epoxide functional groups, as for example one or more amine functional group, one or more alcohol functional groups, one or more thiol functional groups and/or one or more —C(═O)ORx functional groups, with Rx being selected from the group consisting of H and C1-C4 alkyls, preferably methyl or ethyl.

### Compound D

As mentioned above, the at least one compound D has a number of d′ additional functional groups. d′ is an integer equal or greater than 1, for example 2, 3, 4 or 5.

The d′ additional functional groups comprise functional groups capable of reacting with an epoxide functional group and comprising at least one active hydrogen atom.

Examples of d′ additional functional groups comprise primary amine functional groups, secondary amine functional groups, alcohol functional groups, thiol functional groups and—C(═O) OH functional groups.

In a preferred example compound D comprises poly(oxy(methyl-1,2-ethanediyl):

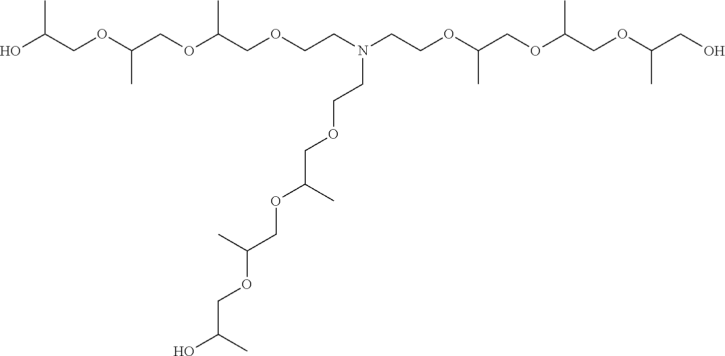 [SMILES: CC(O)COC(C)COC(C)COCCN(CCOCC(C)OCC(C)OCC(C)O)CCOC(C)COC(C)COC(C)CO]

Other examples of compound D comprise polyethyleneglycol (PEG)-based diols and triols and polypropyleneglycol (PPG)-based diols and triols.

Compound D can be chosen to reduce or increase the viscosity and curing rate of the mixture.

### Compound E

As mentioned above, the at least one compound E has a number of e′ primary amine functional groups. e′ is an integer equal or greater than 1, for example 2, 3, 4 or 5. Preferably, e′ is equal to 1.

Compound E does not comprise a pair of functional groups comprising a first primary amine functional group and a second primary amine functional groups, whereby the number of atoms between the first primary amine functional group and the second primary amine functional group is at least 5.

Preferred compounds E comprise one primary amine functional groups. In case compound E comprises more than one e′ primary amine functional groups, these primary amine functional groups can be the same or can be different.

The at least one compound E may further comprise additional functional groups (other than the e′ primary functional groups). Additional functional groups are referred to as e″ additional functional groups. Such e″ additional functional groups comprise for example functional groups capable of reacting with an epoxide functional group and comprising at least one active hydrogen atom. Examples of e″ additional functional groups comprise secondary amine functional groups, alcohol functional groups, thiol functional groups and—C(═O) OH functional groups.

Preferred examples of compound E comprise N-aminoethylpiperazine, N-methyl-1,3-diaminopropane and N-ethyl-N-methylpropane-1,3-diamine.

In a first preferred method a compound A comprising a′ functional groups of the type —C(═O)ORx and/or of the type —C(═O)— and a compound B comprising b′ primary amine functional groups are contacted in step a). At the start of step a), the combined molar amount of b′ primary amine functional groups (Σnⱼ b′ⱼ) is greater (for example substantially greater) than the combined molar amount of a′ functional groups of the type —C(═O)ORx and/or of the type —C(═O)—(Σnⱼ a′ᵢ) so that in step b) b′ primary amine functional groups having active hydrogen atoms are present to react with the c′ epoxide functional groups of the at least one compound C.

Such first preferred method comprises the steps of
a) contacting at least one compound A with at least one compound B, hereby obtaining a mixture comprising or consisting of a curing agent, with the at least one compound A having a′ functional groups of the type —C(═O)ORx and/or of the type —C(═O)—, with a′ being an integer equal or greater than 2 and with Rx for each functional group being independently selected from the group consisting of H and C1-C4 alkyls and with compound A being a cyclic carboxylic acid anhydride in case compound A is having a′ functional groups of the type —C(═O)—,
   with each of the a′ functional groups of the type —C(═O)ORx and/or of the type —C(═O)—belonging to a pair of functional groups comprising a first functional group and a second functional group, whereby the number of atoms between the carbonyl group of the first functional group and the carbonyl group of the second functional group ranges between 2 and 8, and
   with the at least one compound B having b′ primary amine functional groups, with b′ being an integer equal or greater than 2, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom,
   wherein during step a) dynamic bonds are formed by reaction of at least part of the a′ functional groups of the type —C(═O)ORx and/or of the type —C(═O)— with at least part of the b′ primary amine functional groups,
b) contacting the mixture obtained in step a) with at least one compound C, hereby obtaining an epoxy-derived covalent adaptable network, with the at least one compound C having c′ epoxide functional groups, with c′ being an integer equal or greater than 2,
   wherein during step b) permanent bonds are formed by reaction of at least part of the least c′ epoxide functional groups with an active hydrogen atom of a functional group capable of reacting with an epoxide functional group present in the mixture.
   wherein
Σηⱼb′ⱼ being greater than Σnᵢ a′ᵢ
the ratio

$$\frac{\sum {n}_{k} {c}_{k}^{′}}{x}$$

ranging between 0.5 and 1.5, and
the ratio

$$\frac{\sum {n}_{i} {a}_{i}^{′}}{\sum {n}_{i} {a}_{i}^{′} + x}$$

being equal or greater than 0.4 in case x≥Σnₖ C′ₖ

$$\frac{\sum {n}_{i} {a}_{i}^{′}}{\sum {n}_{i} {a}_{i}^{′} + \sum {n}_{k} {c}_{k}^{′}}$$

with
nᵢ being the number of mmol (millimoles) of compound Aᵢ with functionality a′ᵢ,
nⱼ being the number of mmol (millimoles) of compound Bⱼ with functionality b′ⱼ,
   nₖ being the number of mmol (millimoles) of compound Cᵢ with functionality c′ₖ,
   x being the total number of active hydrogen atoms of all functional groups capable of reacting with an epoxide functional group present at the start of step b). With x preferably being the total number of active hydrogen atoms of all b′ functional groups that have not reacted with an a′ primary amine functional group and that are capable of reacting with an epoxide functional group present at the start of step b).

In a second preferred method a compound A comprising a′ functional groups of the type —C(═O)ORx and/or of the type —C(═O)— and a compound B comprising b′ primary amine functional groups and b″ additional functional groups are contacted in step a). The b″ additional functional groups are capable of reacting with an epoxide functional group and comprise at least one active hydrogen atom. In step b) active hydrogen atoms of the b′ primary amine functional groups that have not reacted with an a′ functional group of the type —C(═O)ORx and/or of the type —C(═O)— as well as active hydrogen atoms of the b″ additional functional groups react with the c′ epoxide functional groups of the at least one compound C.

Such second preferred method comprises the steps of
a) contacting at least one compound A with at least one compound B, hereby obtaining a mixture comprising or consisting of a curing agent, with the at least one compound A having a′ functional groups of the type —C(═O)ORx and/or of the type —C(═O)— with a′ being an integer equal or greater than 2 and with Rx for each functional group being independently selected from the group consisting of H and C1-C4 alkyls and with compound A being a cyclic carboxylic acid anhydride in case compound A is having a′ functional groups of the type —C(═O)—,
   with each of the a′ functional groups of the type —C(═O)ORx and/or of the type —C(═O)—belonging to a pair of functional groups comprising a first functional group and a second functional group, whereby the number of atoms between the carbonyl group of the first functional group and the carbonyl group of the second functional group ranges between 2 and 8, and
   with the at least one compound B having b′ primary amine functional groups and having b″ additional functional groups, with b′ being an integer equal or greater than 2 and b″ being an integer equal or greater than 1, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom, with a b″ additional functional groups being selected from the group consisting of primary amine functional groups, secondary amine functional groups, alcohol functional groups, thiol functional groups and —C(═O)OH functional groups,
   wherein during step a) dynamic bonds are formed by reaction of at least part of the a′ functional groups of the type —C(═O)ORx and/or of the type —C(═O)— with at least part of the b′ primary amine functional groups,
b) contacting the mixture obtained in step a) with at least one compound C, hereby obtaining an epoxy-derived covalent adaptable network, with the at least one compound C having c′ epoxide functional groups, with c′ being an integer equal or greater than 2,
   wherein during step b) permanent bonds are formed by reaction of at least part of the least c′ epoxide functional groups with an active hydrogen atom of a functional group capable of reacting with an epoxide functional group present in the mixture.
   wherein
Σηⱼbⱼ′; being equal or greater than Σnⱼ aᵢ′;
the ratio

$$\frac{\sum {n}_{k} {c}_{k}^{′}}{x}$$

ranging between 0.5 and 1.5, and
the ratio

$$\frac{\sum {n}_{i} {a}_{i}^{′}}{\sum {n}_{i} {a}_{i}^{′} + x}$$

being equal or greater than 0.4 in case x<Σnₖ c′ₖ or the ratio

$$\frac{\sum {n}_{i} {a}_{i}^{′}}{\sum {n}_{i} {a}_{i}^{′} + \sum {n}_{k} {c}_{k}^{′}}$$

being equal or greater than 0.4 in case x>Σnₖ c′ₖ
with
   nᵢ being the number of mmol (millimoles) of compound Aᵢ with functionality a′ⱼ,
   nⱼ being the number of mmol (millimoles) of compound Bⱼ with functionality b′ⱼ,
   nₖ being the number of mmol (millimoles) of compound Cᵢ with functionality c′ₖ,
   x being the total number of active hydrogen atoms of all functional groups capable of reacting with an epoxide functional group present at the start of step b). With x preferably being the total number of active hydrogen atoms of all b′ functional groups that have not reacted with an a′ functional group of the type —C(═O)ORx and/or of the type —C(═O)— present at the start of step b) and of all b″ additional functional groups present at the start of step b).

In a third preferred method a compound A comprising a′ functional groups of the type —C(═O)ORx and/or of the type —C(═O)—, a compound B comprising b′ primary amine functional groups and optionally b″ additional functional groups and a compound E comprising e′ primary amine functional groups and optionally e″ additional functional groups are contacted in step a). The b″ additional functional groups and/or the e″ additional functional groups are preferably capable of reacting with an epoxide functional group and preferably comprise at least one active hydrogen atom.

Such third preferred method comprises the steps of
a) contacting at least one compound A with at least one compound B and with at least one compound E, hereby obtaining a mixture comprising or consisting of a curing agent, with the at least one compound A having a′ functional groups of the type —C(═O)ORx and/or of the type —C(═O)— with a′ being an integer equal or greater than 2 and with Rx for each functional group being independently selected from the group consisting of H and C1-C4 alkyls and with compound A being a cyclic carboxylic acid anhydride in case compound A is having a′ functional groups of the type —C(═O)—,
   with each of the a′ functional groups of the type —C(═O)ORx and/or of the type —C(═O)—belonging to a pair of functional groups comprising a first functional group and a second functional group, whereby the number of atoms between the carbonyl group of the first functional group and the carbonyl group of the second functional group ranges between 2 and 8, and
   with the at least one compound B having b′ primary amine functional groups and optionally having b″ additional functional groups, with b′ being an integer equal or greater than 2 and b″ being an integer equal or greater than 0, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom. In case the at least one compound B comprises b″ additional functional groups, such additional functional groups are preferably selected from the group consisting of primary amine functional groups, secondary amine functional
   groups, alcohol functional groups, thiol functional groups and —C(═O) OH functional groups, with the at least one compound E having e′ primary amine functional groups and optionally comprising e″ additional functional groups, with e′ being an integer equal or greater than 1 and e″ being an integer equal or greater than 0, and with compound E not comprising a pair of functional groups comprising a first primary amine functional group and a second primary amine functional groups, whereby the number of atoms between the first primary amine functional group and the second primary amine functional group is at least 5.
   wherein during step a) dynamic bonds are formed by reaction of at least part of the a′ functional groups of the type —C(═O)ORx and/or of the type —C(═O)— with at least part of the b′ primary amine functional groups of the at least one compound D and optionally also by reaction of at least part of the a′ functional groups of the type —C(═O)ORx and/or of the type —C(═O)— with at least part of the e′ primary amine functional groups of the at least one compound E,
b) contacting the mixture obtained in step a) with at least one compound C, hereby obtaining an epoxy-derived covalent adaptable network,
   with the at least one compound C having c′ epoxide functional groups, with c′ being an integer equal or greater than 2,
   wherein during step b) permanent bonds are formed by reaction of at least part of the least c′ epoxide functional groups with an active hydrogen atom of a functional group capable of reacting with an epoxide functional group present in the mixture.
   wherein
Σηⱼ b′ⱼ being equal or greater than Σnᵢ a′ᵢ
the ratio

$$\frac{\sum {n}_{k} {c}_{k}^{′}}{x}$$

ranging between 0.5 and 1.5, and
the ratio

$$\frac{\sum {n}_{i} {a}_{i}^{′}}{\sum {n}_{i} {a}_{i}^{′} + x}$$

being equal or greater than 0.4 in case x<Σnₖ c′ₖ or the ratio

$$\frac{\sum {n}_{i} {a}_{i}^{′}}{\sum {n}_{i} {a}_{i}^{′} + \sum {n}_{k} {c}_{k}^{′}}$$

being equal or greater than 0.4 in case x>Σnₖ c′ₖ
with
   nᵢ being the number of mmol (millimoles) of compound Aᵢ with functionality a′ⱼ,
   nⱼ being the number of mmol (millimoles) of compound Bⱼ with functionality b′ⱼ,
   nₖ being the number of mmol (millimoles) of compound Cᵢ with functionality c′ₖ,
   x being the total number of active hydrogen atoms of all functional groups capable of reacting with an epoxide functional group present at the start of step b). With x preferably being the total number of active hydrogen atoms of all b′ functional groups that have not reacted with an a′ functional group of the type —C(═O)ORx and/or of the type —C(═O)— present at the start of step b), the total number of active hydrogen atoms of all b″ additional functional groups present at the start of step b) and the total number of active hydrogen atoms of all e′ functional groups that have not reacted with an a′ functional group of the type —C(═O)ORx and/or of the type-C(═O)— present at the start of step b) and the total number of active hydrogen atoms of all e″ additional functional groups present at the start of step b).

In a fourth preferred method a compound A comprising a′ functional groups of the type —C(═O)ORx and/or of the type —C(═O)— and a compound B comprising b′ primary amine functional groups and optionally b″ additional functional groups are contacted in step a). The b″ additional functional groups are preferably capable of reacting with an epoxide functional group and preferably comprise at least one active hydrogen atom.

In step b) at least one compound D is added to the start mixture. The at least one compound D comprises one or more d′ additional functional group. The d′ additional functional groups are capable of reacting with an epoxide functional group and comprise at least one active hydrogen atom. In step b) the active hydrogen atoms of the d′ additional functional groups may react with the c′ epoxide functional groups of the at least one compound C. It is clear that also active hydrogen atoms of the b′ primary amine functional groups that have not reacted with an a′ functional group of the type —C(═O)ORx and/or of the type —C(═O)— as well as active hydrogen atoms of the b″ additional functional groups can react with the c′ epoxide functional groups of the at least one compound C.

Such fourth preferred method comprises the steps of
a) contacting at least one compound A with at least one compound B, hereby obtaining a mixture comprising or consisting of a curing agent, with the at least one compound A having a′ functional groups of the type —C(═O)ORx and/or of the type —C(═O)— with a′ being an integer equal or greater than 2 and with Rx for each functional group being independently selected from the group consisting of H and C1-C4 alkyls and with compound A being a cyclic carboxylic acid anhydride in case compound A is having a′ functional groups of the type —C(═O)—,
   with each of the a′ functional groups of the type —C(═O)ORx and/or of the type —C(═O)—belonging to a pair of functional groups comprising a first functional group and a second functional group, whereby the number of atoms between the carbonyl group of the first functional group and the carbonyl group of the second functional group ranges between 2 and 8, and
   with the at least one compound B having b′ primary amine functional groups and having b″ additional functional groups, with b′ being an integer equal or greater than 2 and b″ being an integer equal or greater than 0, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom. In case the at least one compound B comprises b″ additional functional groups, such additional functional groups are preferably selected from the group consisting of primary amine functional groups, secondary amine functional groups, alcohol functional groups, thiol functional groups and —C(═O) OH functional groups
   wherein during step a) dynamic bonds are formed by reaction of at least part of the a′ functional groups of the type —C(═O)ORx and/or of the type —C(═O)— with at least part of the b′ primary amine functional groups,
b) contacting the mixture obtained in step a) further comprising at least one compound D with at least one compound C, hereby obtaining an epoxy-derived covalent adaptable network, with the at least one compound C having c′ epoxide functional groups, with c′ being an integer equal or greater than 2, with the at least one compound D having d′ additional functional groups, with d′ being an integer equal or greater than 1 and with the d′ additional functional groups being selected from the group consisting of primary amine functional groups, secondary amine functional groups, alcohol functional groups, thiol functional groups and —C(═O) OH functional groups,
   wherein during step b) permanent bonds are formed by reaction of at least part of the least c′ epoxide functional groups with an active hydrogen atom of a functional group capable of reacting with an epoxide functional group present in the mixture.
   wherein
Σnⱼ b′ⱼ being equal or greater than Σnᵢ a′ᵢ
the ratio

$$\frac{\sum {n}_{k} {c}_{k}^{′}}{x}$$

ranging between 0.5 and 1.5, and
the ratio

$$\frac{\sum {n}_{i} {a}_{i}^{′}}{\sum {n}_{i} {a}_{i}^{′} + x}$$

being equal or greater than 0.4 in case x<Σnₖ c′ₖ

$$\frac{\sum {n}_{i} {a}_{i}^{′}}{\sum {n}_{i} {a}_{i}^{′} + \sum {n}_{k} {c}_{k}^{′}}$$

with
nᵢ being the number of mmol (millimoles) of compound Aᵢ with functionality a′ⱼ,
   nⱼ being the number of mmol (millimoles) of compound Bⱼ with functionality b′ⱼ,
   nₖ being the number of mmol (millimoles) of compound Cᵢ with functionality c′ₖ,
   x being the total number of active hydrogen atoms of all functional groups capable of reacting with an epoxide functional group present at the start of step b). With x preferably being the total number of active hydrogen atoms of all b′ functional groups that have not reacted with an a′ functional group of the type —C(═O)ORx and/or of the type —C(═O)— present at the start of step b), the total number of active hydrogen atoms of all b″ additional functional groups present at the start of step b) and the total number of active hydrogen atoms of all d′ functional groups present at the start of step b).

According to a second aspect of the present invention, a composition comprising an epoxy-based covalent adaptable network is provided. The composition is obtainable by the above-described method.

According to a third aspect of the present invention, the use of a composition comprising an epoxy-based covalent adaptable network, preferably an epoxy-based covalent adaptable network obtainable by the above-described method is provided. The composition comprising the epoxy-based covalent adaptable network is for example used as adhesive or coating.

In particular embodiments the composition comprising the epoxy-based covalent adaptable network is used as encapsulation material of electronic components.

### BRIEF DESCRIPTION OF THE DRAWINGS

The present invention will be discussed in more detail below, with reference to the attached drawings, in which:

FIG. 1 shows the synthesis strategy of a polyamide resin (example 1) starting from methyl ester of dicarboxylic acid, trifunctional amine tris(2-aminoethyl)amine (TREN) as a cross-linker and bifunctional Priamine 1074 as a chain extender to obtain a polyamide resin;

FIG. 2 shows the synthesis strategy of a composition (example 2) comprising an epoxy-based covalent adaptable network according to the present invention starting from methyl ester of dicarboxylic acid, trifunctional amine tris(2-aminoethyl)amine (TREN) and 1,4-Butanediol diglycidyl ether;

FIG. 3 shows the thermal stability of example 1 and example 2 by depicting the isothermal TGA measurement measured at 200° C. of the composition of example 1 and at 200° C. and 250° C. of the composition of example 2 for 120 minutes;

FIG. 4 depicts the relaxation time as a function of temperature to display the difference in dynamic behavior of example 1 and example 2;

FIG. 5 and FIG. 6 depict the non-normalized stress-relaxation data of respectively example 1 and example 2 at different temperatures;

FIG. 7 shows the thermal stability (isothermal TGA) of examples 007B, 009A and 009B at 200° C. for 120 minutes;

FIG. 8 shows the thermal stability (isothermal TGA) of examples 011B, 011C and 018K at 200° C. for 120 minutes;

FIG. 9 shows the thermal stability (isothermal TGA) of examples 012A and 016B at 250° C. for 120 minutes;

FIG. 10 shows the thermal stability (isothermal TGA) of examples 024B, 026A and 026B at 250° C. for 120 minutes;

FIGS. 11a, 11b and 11c show respectively the synthesis strategy, the stress-relaxation behavior and the shear-viscosity plot of example 007B;

FIGS. 12 to 22 show the synthesis strategy, the stress-relaxation behavior and the shear-viscosity plot of examples 009A, 009B, 011B, 011C, 018K, 012A, 16D, 024B, 026A, 026B and 027B;

FIGS. 23a, 23b and 23c show respectively creep data, shear viscosity plot (obtained from stress-relaxation measurement) and zero-shear viscosity plot (obtained from creep measurement) of example 016C;

FIG. 24 shows the frequency sweep data of example 024B.

### DESCRIPTION OF EMBODIMENTS

The present invention will be described with respect to particular embodiments and with reference to certain drawings; but the invention is not limited thereto but only by the claims. The drawings are only schematic and are non-limiting. The size of some of the elements in the drawing may be exaggerated and not drawn to scale for illustrative purposes. The dimensions and the relative dimensions do not correspond to actual reductions to practice of the invention.

When referring to the endpoints of a range, the endpoint values of the range are included.

When describing the invention, the terms used are construed in accordance with the following definitions, unless indicated otherwise.

The term ‘and/or’ when listing two or more items, means that any one of the listed items can by employed by itself or that any combination of two or more of the listed items can be employed.

A number of compositions were synthesized and evaluated using the characterisation procedures given below.

Thermogravimetric analyses (TGA) were performed on a Mettler-Toledo TGA/SDTA 851e instrument. Isothermal thermogravimetric measurements were performed under nitrogen atmosphere at 200° C. or 250° C. for 120 minutes with a heating rate of 10° K.min^{-1.}

A Mettler Toledo instrument 1/700 was used to perform differential scanning calorimetry (DSC) measurements under nitrogen atmosphere with a heating rate of 10 K.min⁻¹ and a cooling rate of 10 K.min⁻¹. Several cycles of measurements were performed from −50° C. to 150° C. The glass transition temperature (Tg) was determined at the second cycle.

Attenuated total reflection Fourier Transform Infrared (ATR-FTIR) analysis were realized on a Perkin-Elmer Spectrum1000 FTIR infrared spectrometer equipped with a diamond ATR probe.

The networks were (re) processed using compression molding. Samples were cut or grinded to small pieces of roughly 1 to 2 mm diameter size and placed in a steel mold. The mold was transferred to a heated plate press at 200° C. or 250° C. for 15 min to 90 min at 2 to 4 metric ton of pressure. The samples were removed after cooling the mold to ˜ 80 to 100° C.

Stress-relaxation experiments were performed using an Anton-Paar MCR 302 rheometer with a plate diameter of 8 mm and on samples having a diameter of 8 mm and a thickness of 1 mm. Then stress-relaxation experiments were performed using a shear strain of 0.5% and a constant force of 1 N. By fitting the relaxation modulus (G(t) in Pa) data to a single exponential decay (Single Maxwell according to equation (1):

$$G ( t ) = {G}_{O} {e}^{( \frac{t}{{τ}^{*}} )} \qquad ( 1 )$$

a relaxation time (τ* in s) can be obtained and related to the shear viscosity (ηₛₕₑₐᵣ in Pa·s) according to equation (2): η=τ*G (2) with the shear modulus G˜G₀. The initial relaxation modulus (G₀ in Pa) was obtained from the stress-relaxation data at 1 s. Monitoring the ηₛₕₑₐᵣ as a function of temperature allows to determine the flow capacity or dynamic behavior of the epoxy-derived covalent adaptable network. Moreover, by plotting In(ηₛₕₑₐᵣ) as a function of 1000/T (K⁻¹), an activation energy (E_{α, η} in kj. mol⁻¹) could be obtained from the slope of the (linear part of the) curve.

Frequency sweep experiments were performed using an Anton-Paar MCR rheometer using a strain of 0.5% while a normal force of 1 N was applied and a frequency range from 0.01 to 100 rad.s⁻¹ was screened by following the evolution of G′ and G″ at a constant temperature. Subsequently the same process was repeated at different temperatures from high to low.

Creep experiments at different temperatures (50 to 120° C., with intervals of 10° C.) were also performed on an Anton-Paar MCR rheometer using an applied force of 1 N. A 2000 Pa shear stress (o in Pa) was applied for 5000 s, and the shear strain was monitored as a function of time. From the slope of the steady-state region (4000 s to 5000 s), creep rate values (¿ in s⁻¹) were calculated and related to the zero-shear viscosity (η_{zero-shear} in Pa) according to equation (3):

$${η}_{zero - shear} = \frac{σ}{\dot{ε}} . \qquad ( 3 )$$

Monitoring the η_{zero-shear} as a function of temperature allows to determine the flow capacity or dynamic behavior of the epoxy-derived covalent adaptable network. Moreover, by plotting In (η_{zero-shear}) as a function of 1000/T (K⁻¹), an activation energy (E_{α, η0}kj·mol⁻¹) could be obtained from the slope of the (linear part of the) curve.

### EXAMPLES

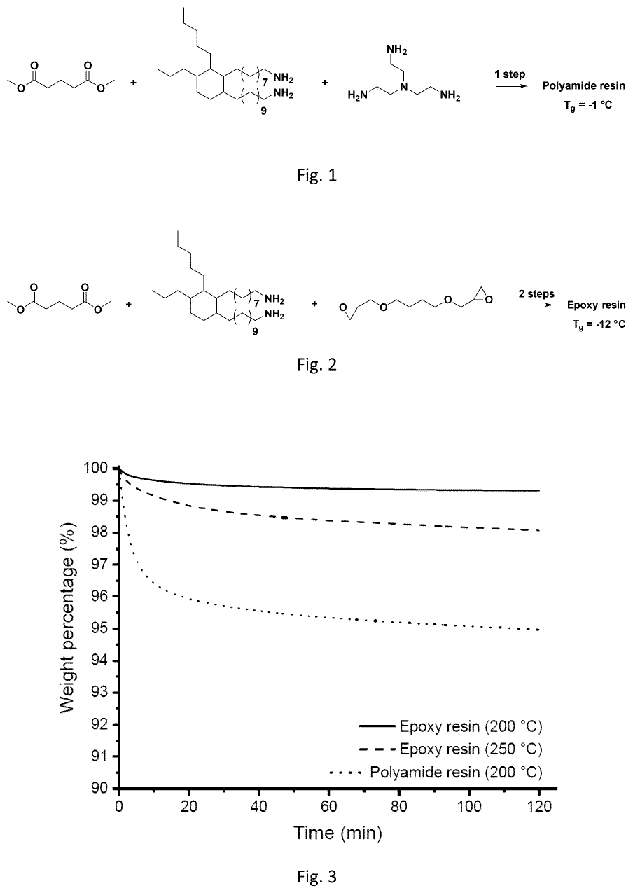

A polyamide resin (example 1) was synthesized following the synthesis strategy shown in FIG. 1. A composition (example 2) comprising an epoxy-based covalent adaptable network according to the present invention was synthesized following the synthesis strategy shown in FIG. 2. Details of the synthesis of example 1 and example 2 are given below.

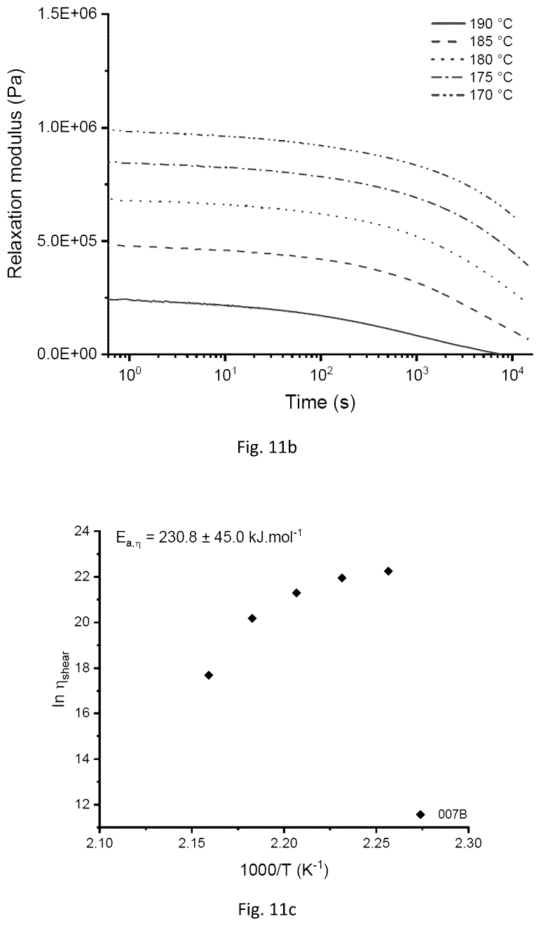

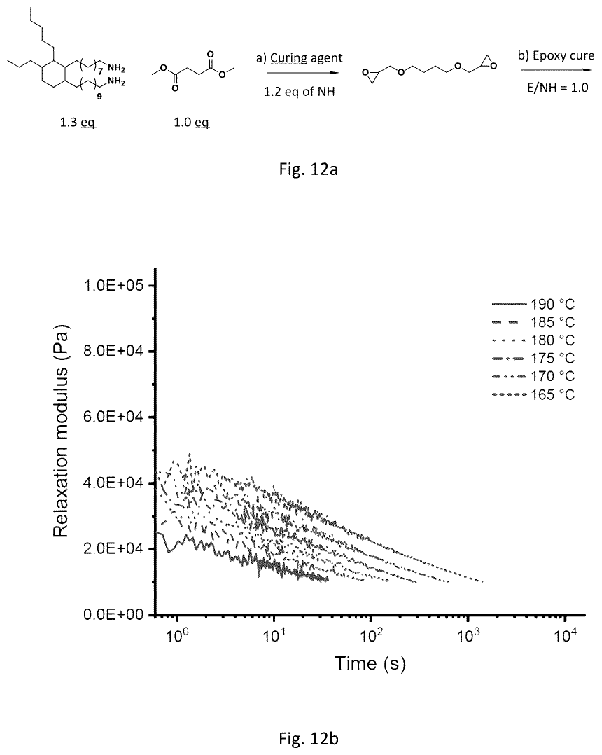

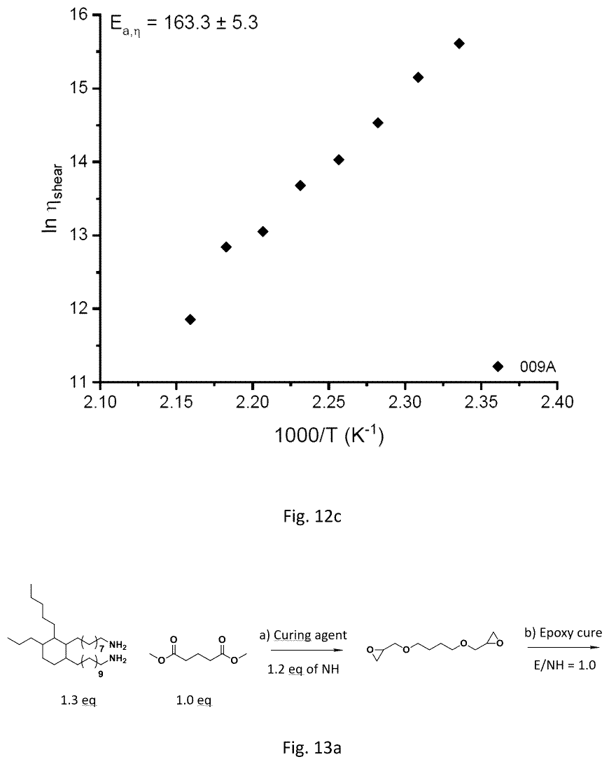

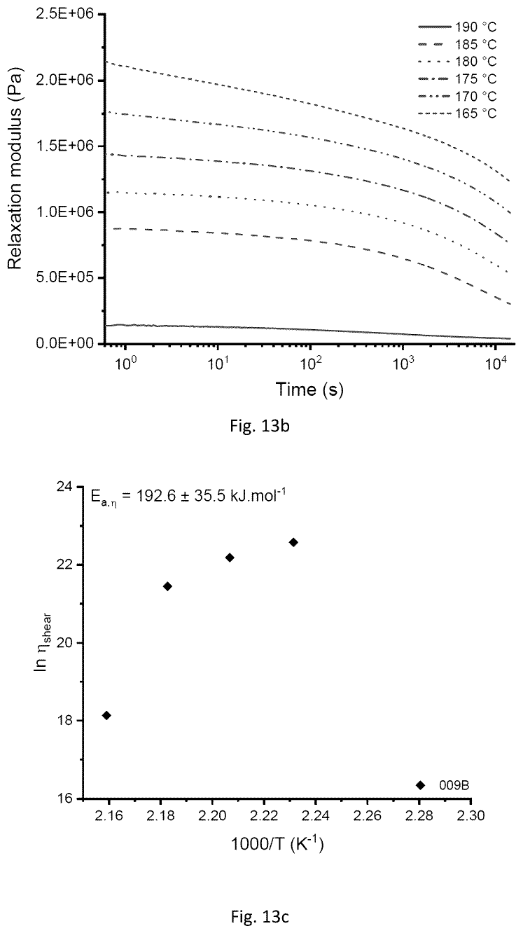

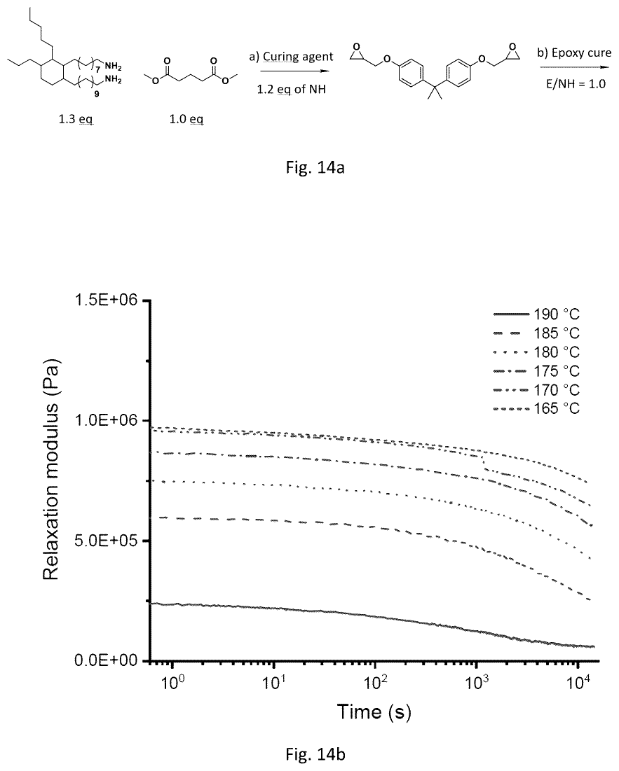

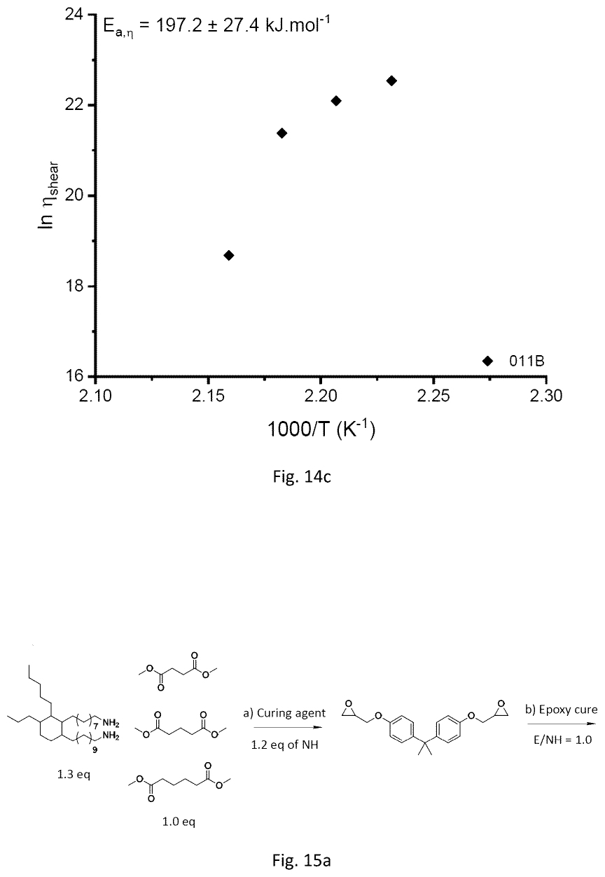

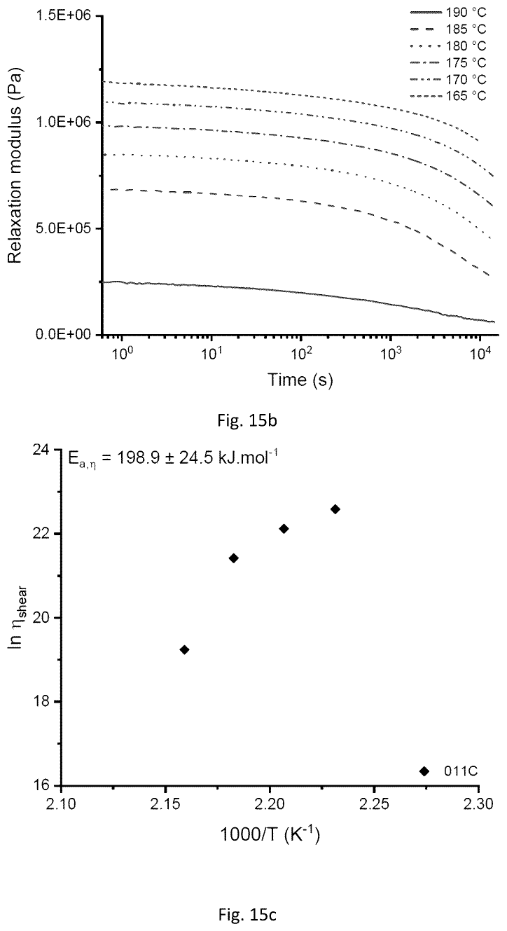

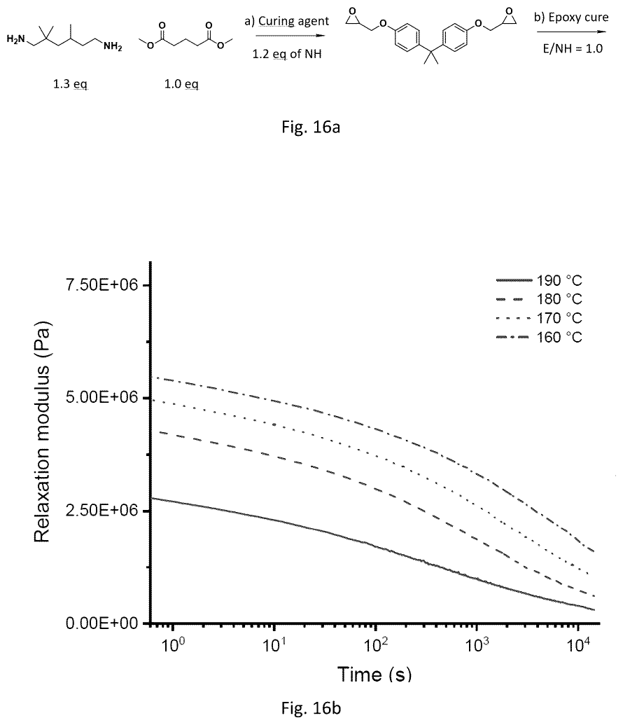

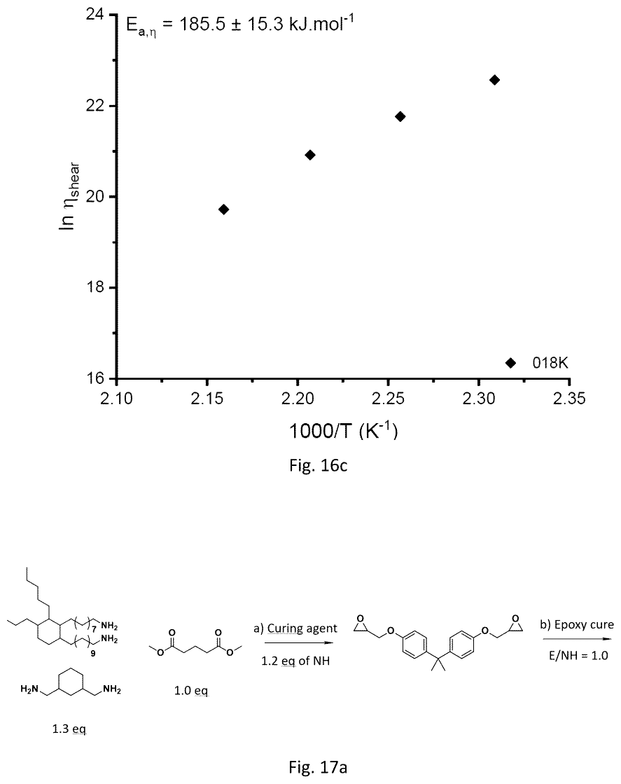

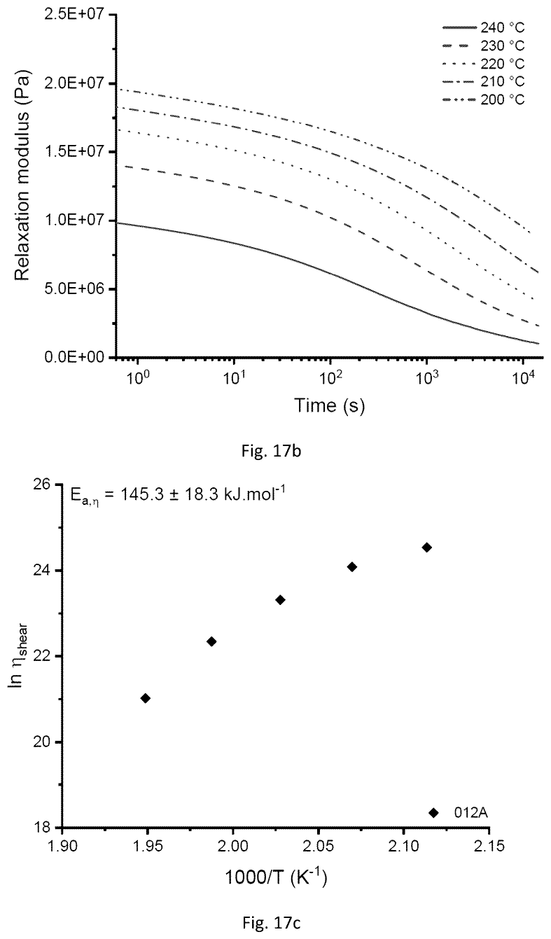

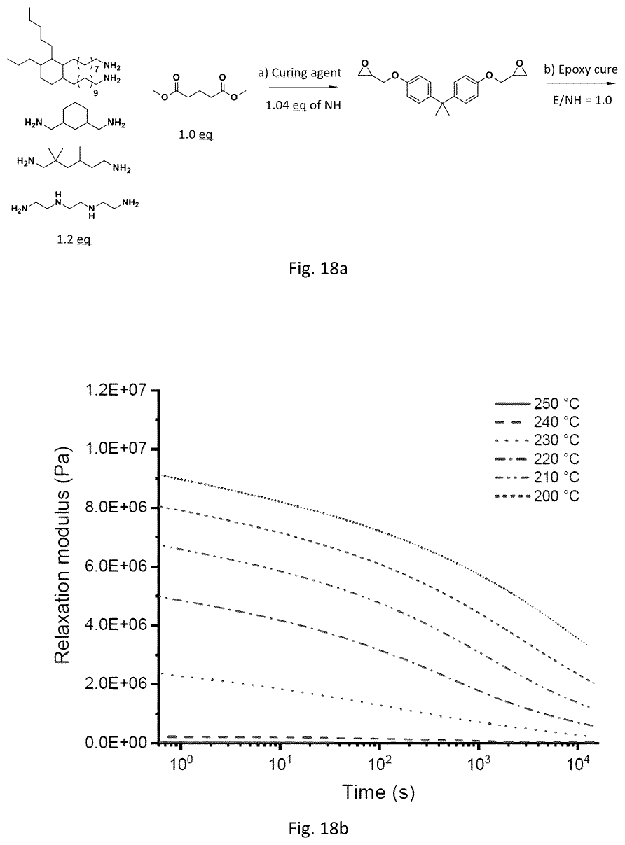

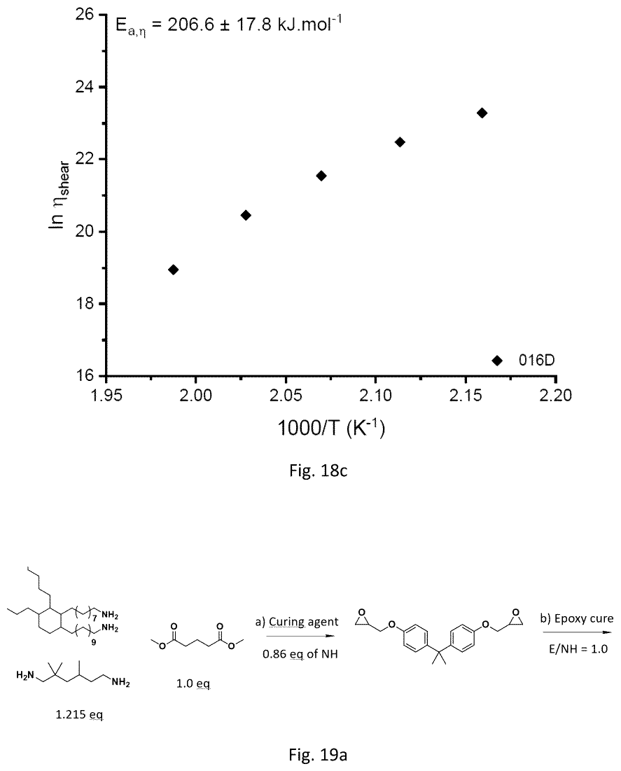

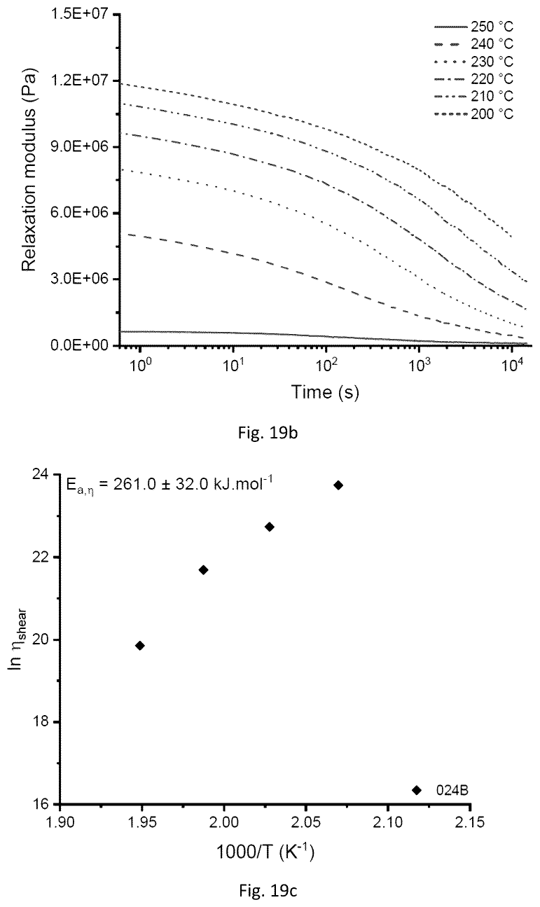

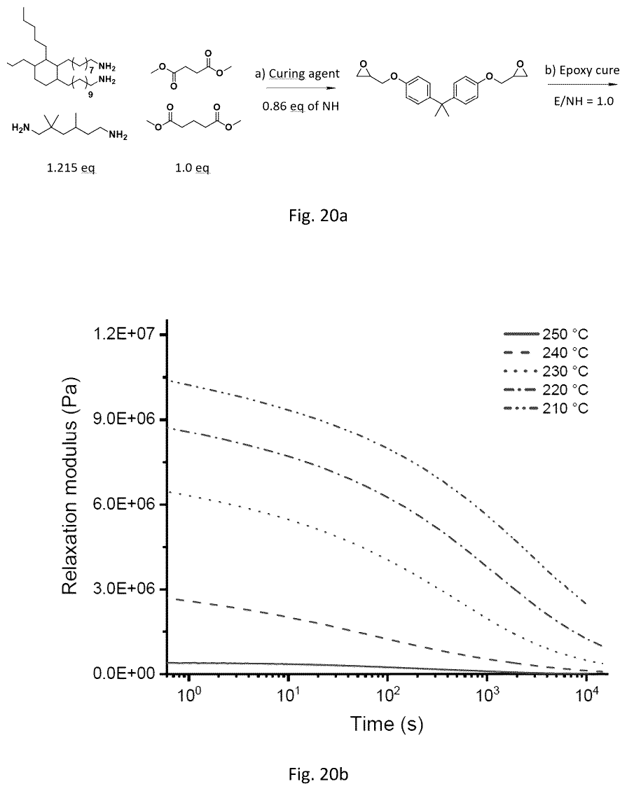

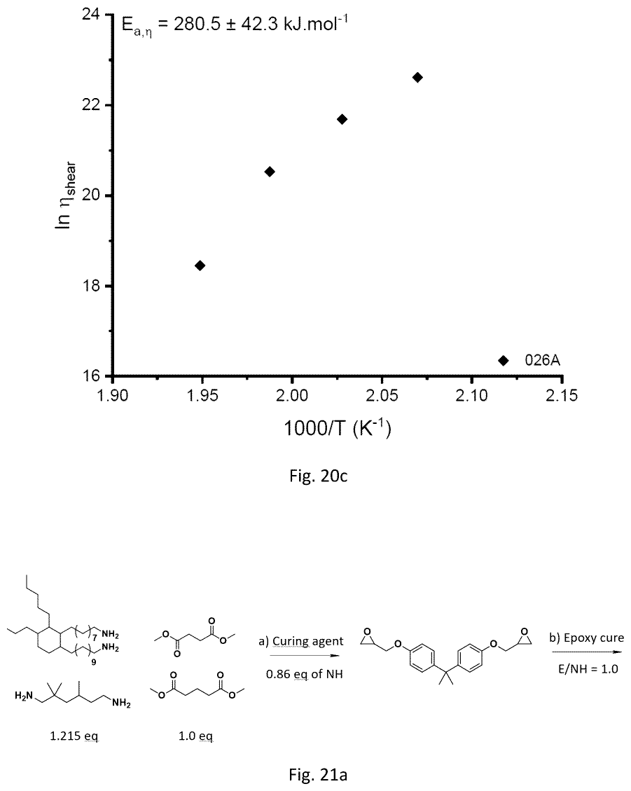

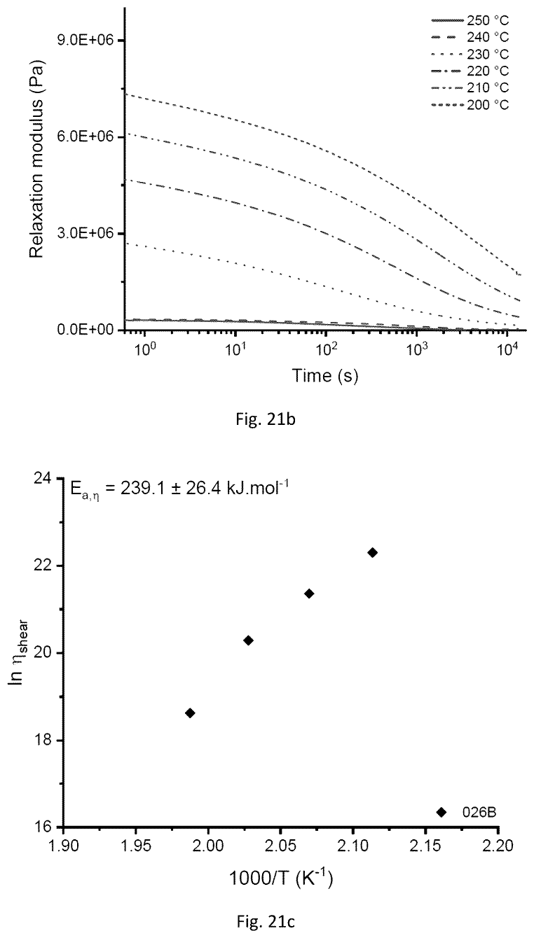

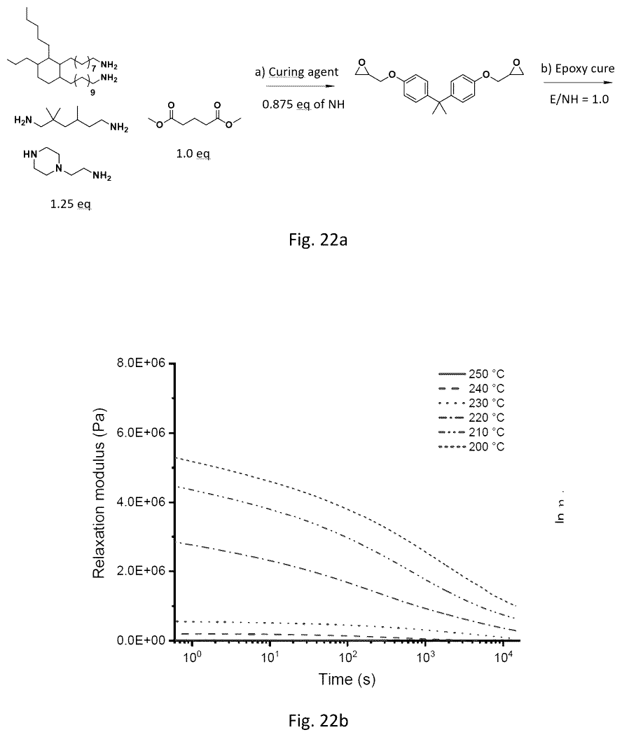

FIGS. 11 to 22 show the synthesis strategy, the stress-relaxation behavior and the shear-viscosity plot of particular examples. In a shear viscosity plot In ηshearin function of 1000/T (in K⁻¹) is plotted.

### Example 1

Dimethyl glutarate (1.83 g, 11.4 mmol, 1 equiv), TREN (0.67 g, 4.57 mmol, 0.4 equiv), and Priamine 1074 (2.5 g, 4.57 mmol, 0.4 equiv) were mixed in a 20 mL polypropylene cup using a DAC 150.1 FVZ speed mixer (typical conditions of mixing: 2 min with a speed of 2500 rpm). Then, the cup was placed in an oven at 100° C. for 24 h to initiate the network formation. Hereafter, the network was further cured for 24 h at 100° C. under vacuum.

### Example 2

Dimethyl glutarate (0.79 g, 4.92 mmol, 1 equiv) and Priamine 1074 (3.5 g, 6.40 mmol, 1.3 equiv) were mixed in a 20 mL polypropylene cup first using a DAC 150.1 FVZ speed mixer (typical conditions of mixing: 2 min with a speed of 2500 rpm). Then, the cup was placed in an oven at 80° C. for 24 h to prepare the dynamic curing agent. Next, 1,4-butanediol diglycidyl ether (0.59 g, 2.95 mmol, 0.6 equiv) was added to the mixture and speed mixing was repeated until a homogeneous viscous liquid was obtained. Hereafter, the network was heated in an oven at 80° C. for 4 h to initiate curing. Subsequently, the network was cured for 24 h at 100° C. under vacuum.

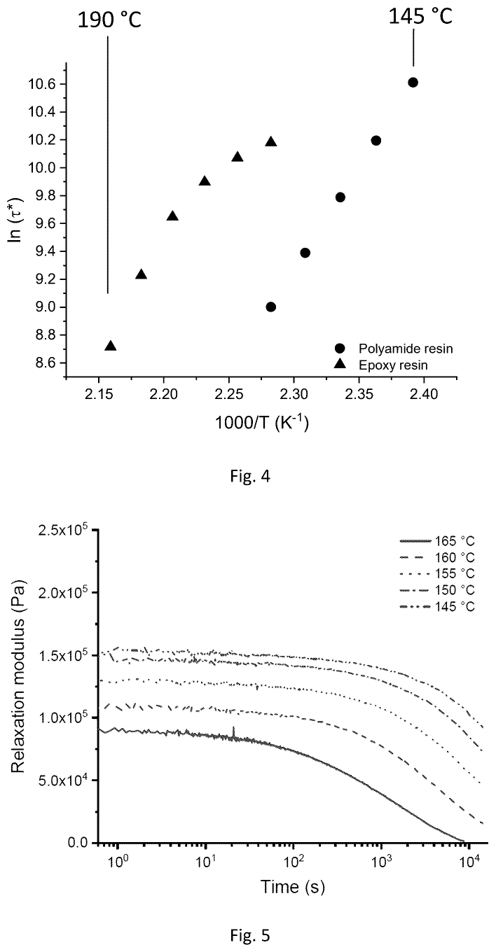

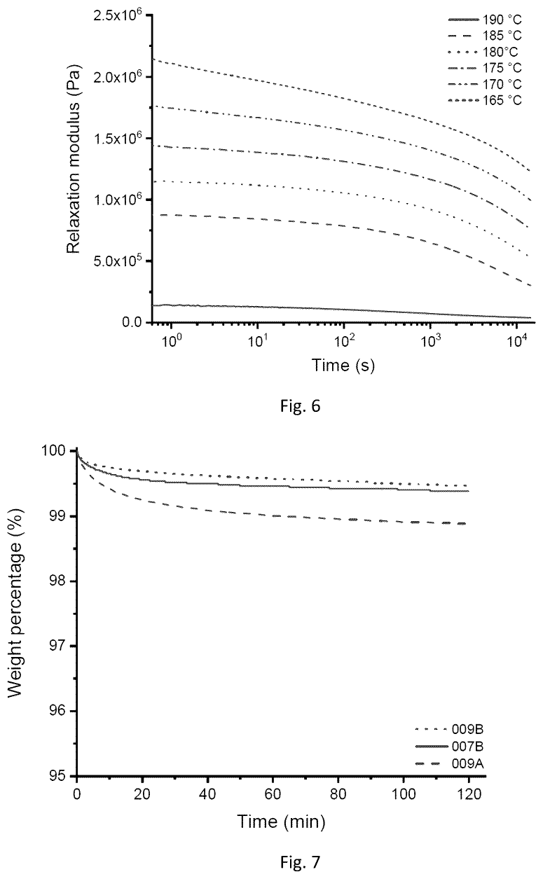

FIGS. 3-6, described herein earlier, show selected results of the characterisations performed on example 1 (comparative example) and example 2 (example according to the present invention). As can be observed from FIG. 3, the weight loss of a composition according to the present invention is considerably lower even at a temperature of 250° C. FIG. 4 shows that example 1 has a higher thermal stability and higher processing temperature than example 2. FIG. 5 and FIG. 6 show the relaxation modulus (in Pa) in function of the relaxation time t* (in s).

### Further Examples

A range of a composition comprising an epoxy-based covalent adaptable network according to the present invention were synthesised according to the method of the present invention starting from varying combinations of the compounds A, B, C and E given in respectively in Table 3, Table 4, Table 5 and Table 6. The formulations of a number of examples are given in Table 7, Table 8 and Table 9.

TABLE 3
examples of compound A

| Reference | Short | |
|---|---|---|
| Number | reference | compound |
| 11 | Succ | 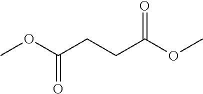 Dimethylsuccinate |
| 12 | Glut | 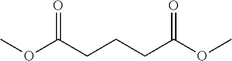 Dimethylglutarate |
| 13 | Adip | 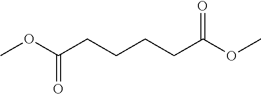 Dimethyladipate |

TABLE 4
examples of compound B

| Refer- | | |
|---|---|---|
| ence | Short | |
| Num- | refer- | |
| ber | ence | compound |
| 21 | Pri- amine | 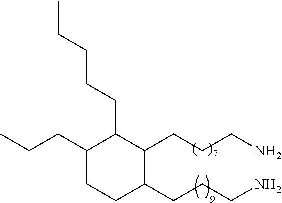 Priamine 1074 |
| 22 | Tri- meth- yl | 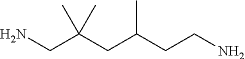 2,2,4-trimethylhexane-1,6-diamine |
| 23 | Cyclo- hexbis | 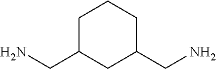 1,3-bis(aminomethyl)cyclohexane |
| 24 | | 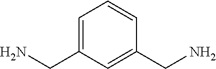 m-xylenediamine |
| 25 | TETA | 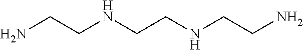 Triethylenetetramine |
| 26 | | 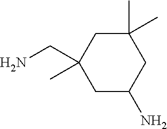 Isophoronediamine |

TABLE 5
examples of compound C

| Reference | Short | |
|---|---|---|
| Number | reference | compound |
| 31 | BDDGE | 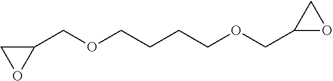 [SMILES: C(CCOCC1CO1)COCC1CO1] 1,4-butanedioldiglycidylether |
| 32 | DER 332 | 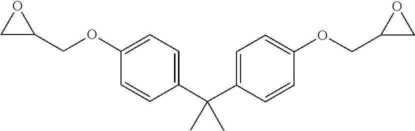 [SMILES: CC(C)(c1ccc(OCC2CO2)cc1)c1ccc(OCC2CO2)cc1] Bisphenol A diglycidyl ether |

TABLE 6
example of compound E

| Reference | Short | |
|---|---|---|
| Number | reference | compound |
| 41 | Piperazil | 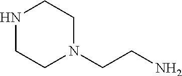 N-aminoethylpiperazine |

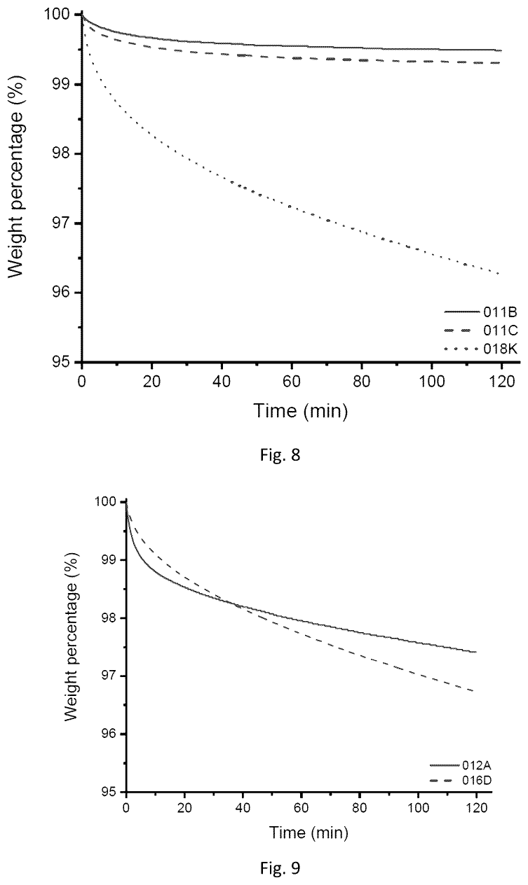

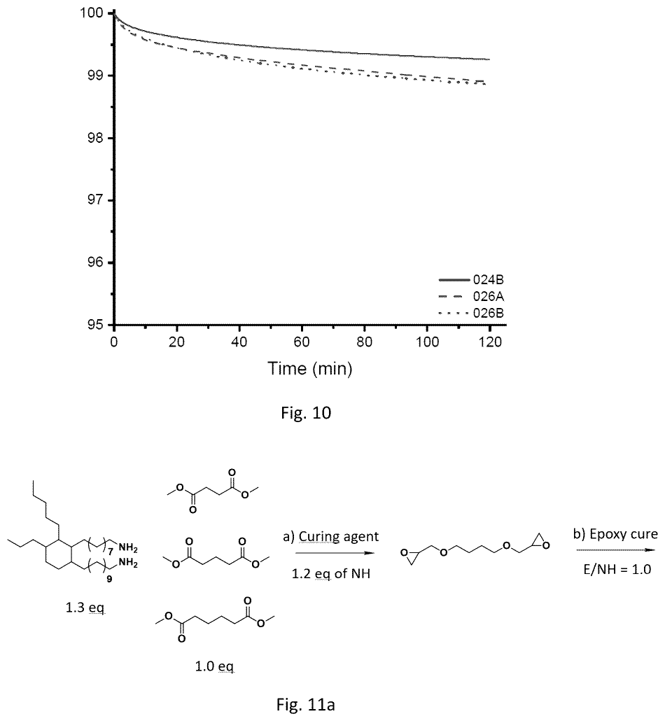

FIGS. 7-10, described herein earlier, display the thermal stability based on the composition depicted in Table 7. Examples comprising a fraction of fatty amine (Priamine 1074) show a higher thermal stability.

FIGS. 11-22 show the synthesis strategy, the stress-relaxation behavior and the shear-viscosity plot of particular examples. Starting from varying combinations of the compounds A, B, C and E, an optimal balance between cross-linking density and material flow is depicted. Materials with a large variation in glass transition temperature (Tg) were obtained. Despite resulting in highly cross-linked networks a sharp decrease in viscosity (i.e. activation energy values above 200 KJ.mol-1) could be obtained in a relatively short temperature range. The observed decrease in viscosity is both a result of reversible chain-cleavage (loss in modulus) and exchange of the dissociated intermediates (relaxation). As a result, these epoxy-derived covalent adaptable networks only show sufficient (re) processability at higher temperatures.

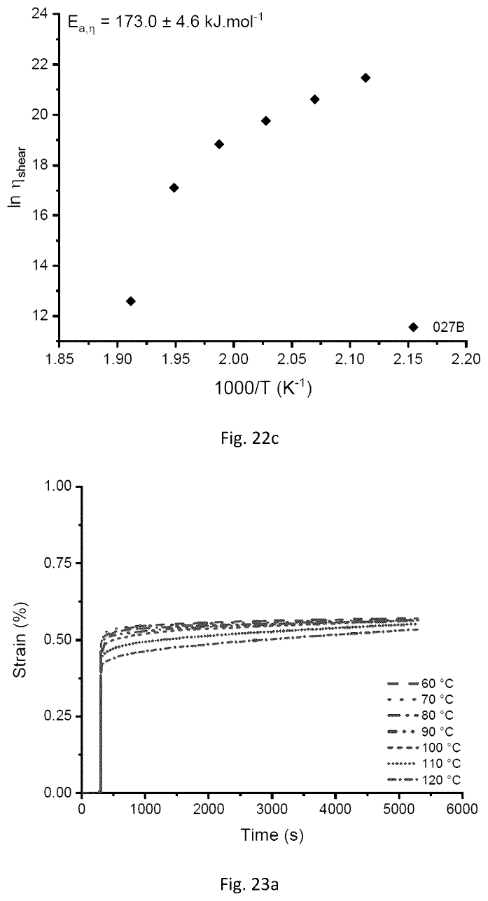

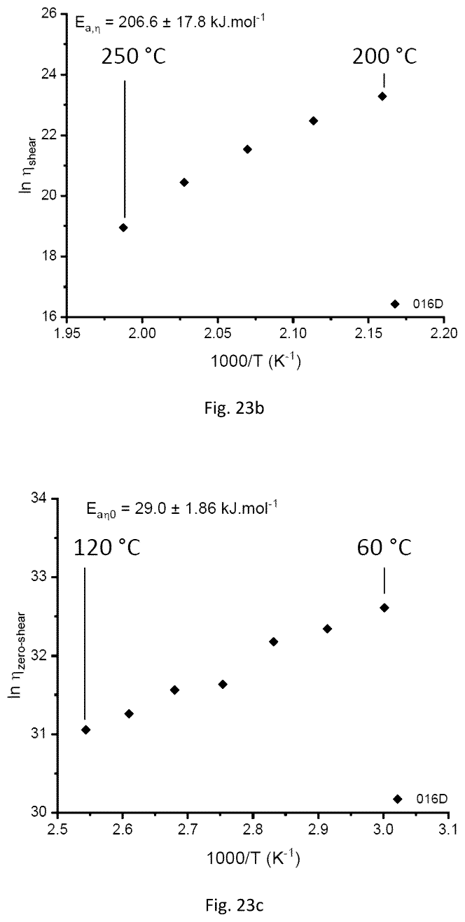

FIG. 23 shows the results of the creep experiments and corresponding viscosity plot compared to the stress-relaxation data of particular examples. A drastic difference between dynamic behavior is observed at 200° C. to 250° C. (high activation energy or sharp decrease in viscosity obtained from high temperature stress-relaxation) and at 60° C. to 120° C. (low activation energy or low decrease in viscosity obtained from low temperature creep experiment).

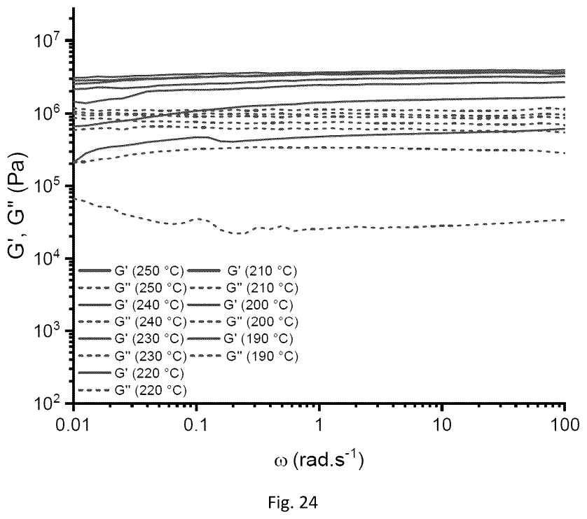

FIG. 24 displays the result of frequency sweep experiments of particular examples. Prolonged heating at higher temperatures did not result in significant degradation or decrease in material properties, since going from 250° C. to 190° C. resulted in a recovery of cross-linking density with high plateau storage moduli values between 106 and 107 Pa

TABLE 7

| | Compound | Compound | Compound | Compound | Dynamic | Compound | T_{g} |
|---|---|---|---|---|---|---|---|
| Example | B1 | A1 | A2 | A3 | bonds | C | (° C.) |
| 007B | Priamine | Succ | Glut | Adip | 63% | BDDGE | −13 |
| | (100%) | (22%) | (60%) | (100%) | | | |
| 009A | Priamine | Succ | — | — | 63% | BDDGE | −13 |
| | (100%) | (100%) | | | | | |
| 009B | Priamine | — | Glut | — | 63% | BDDGE | −12 |
| | (100%) | | (100%) | | | | |
| 011B | Priamine | — | Glut | — | 63% | DER332 | 11 |
| | (100%) | | (100%) | | | | |
| 011C | Priamine | Succ | Glut | Adip | 63% | DER332 | 8 |
| | (100%) | (22%) | (60%) | (100%) | | | |

TABLE 8

| | Compound | Compound | Compound | Compound | Compound | Compound | Dynamic | Compound | T_{g} |
|---|---|---|---|---|---|---|---|---|---|
| Example | B1 | B2 | B3 | B4 | A1 | A2 | bonds | C | (° C.) |
| 012A | Priamine | Cyclohexbis | | | | Glut | 63% | DER332 | 71 |
| | (30%) | (70%) | | | | (100%) | | | |
| 016D | Pramine | Cyclohexbis | Trimethyl | TETA | | Glut | 63% | DER332 | 43 |
| | (30%) | (30%) | (30%) | (10%) | | (100%) | | | |
| 018K | | | | Trimethyl | | Glut | 63% | DER332 | 67 |
| | | | | (100%) | | (100%) | | | |
| 024B | Priamine | | Trimethyl | | | Glut | 70% | DER332 | 43 |
| | (40%) | | (60%) | | | (100%) | | | |
| 026A | Priamine | | Trimethyl | | Succ | Glut | 70% | DER33 | 34 |
| | (40%) | | (60%) | | (30%) | (70%) | | | |
| 026B | Priamine | | Trimethyl | | Succ | Glut | 70% | DER332 | 19 |
| | (40%) | | (60%) | | (50%) | (50%) | | | |
| 027B | Priamine | Piperazil | Trimethyl | | | Glut | 63% | DER332 | 39 |
| | (30%) | (10%) | (60%) | | | (100%) | | | |

TABLE 9

| | Compound | Compound | Compound | Compound | Compound | Dynamic | Compound | T_{g} |
|---|---|---|---|---|---|---|---|---|
| Example | B1 | B2 | B3 | B4 | A2 | bonds | C | (° C.) |
| 029D | Priamine | Piperazil | Cyclohex | TETA | Glut | 63% | DER332 | 55 |
| | (30%) | (10%) | (40%) | (20%) | (100%) | | | |

1. A method for preparing a composition comprising an epoxy-based covalent adaptable network comprising the steps of
a) contacting at least one compound A with at least one compound B, hereby obtaining a mixture comprising a curing agent,
with the at least one compound A having a′ functional groups of the type —C(═O)ORx and/or of the type —C(═O)—, with a′ being an integer equal or greater than 2 and with Rx for each functional group being independently selected from the group consisting of H and C1-C4 alkyls, with each of the a′ functional groups of the type —C(═O)ORx and/or of the type —C(═O)— belonging to a pair of functional groups comprising a first functional group and a second functional group, whereby the number of atoms between the carbonyl group of the first functional group and the carbonyl group of the second functional group ranges between 2 and 8, and whereby in case the at least one compound A comprises a pair of functional groups having a functional group of the type —(C═O)— as first and as second functional group, the at least one compound A comprises a cyclic carboxylic acid anhydride with the first and the second functional groups belonging to the carboxylic acid functional group of the at least one compound A, and
with the at least one compound B having b′ primary amine functional groups, with b′ being an integer equal or greater than 2, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom,
wherein during step a) dynamic bonds are formed by reaction of at least part of the a′ functional groups of the type —C(═O)ORx and/or of the type —C(═O)— with at least part of the b′ primary amine functional groups,
b) contacting the mixture obtained in step a) with at least one compound C, hereby obtaining an epoxy-derived covalent adaptable network,
with the at least one compound C having c′ epoxide functional groups, with c′ being an integer equal or greater than 2,
wherein during step b) permanent bonds are formed by reaction of at least part of the least c′ epoxide functional groups with an active hydrogen atom of a functional group capable of reacting with an epoxide functional group present in the mixture,
wherein
Σnⱼb′ⱼ being equal or greater than Σnᵢa′ᵢ
the ratio
$$\frac{\sum {n}_{k} {c}_{k}^{′}}{x}$$
ranging between 0.5 and 1.5, and
the ratio
$$\frac{\sum {n}_{i} {a}_{i}^{′}}{\sum {n}_{i} {a}_{i}^{′} + x}$$
being equal or greater than 0.4 in case x<Σnₖc′ₖ or the ratio
$$\frac{\sum {n}_{i} {a}_{i}^{′}}{\sum {n}_{i} {a}_{i}^{′} + \sum {n}_{k} {c}_{k}^{′}}$$
being equal or greater than 0.4 in case <Σeₖc′ₖ
with
nᵢ being the number of mmol of compound Aᵢ with functionality a′ⱼ,
nⱼ being the number of mmol of compound Bⱼ with functionality b′ⱼ,
nₖ being the number of mmol of compound Cᵢ with functionality c′ₖ.
X being the total number of active hydrogen atoms of all functional groups capable of reacting with an epoxide functional group present at the start of step b).

2. The method according to claim 1, wherein the number of atoms between the carbonyl group of the first functional group and the carbonyl group of the second functional group of a pair of a′ functional groups of the type —C(═O)ORx and/or of the type —C(═O)— is 2, 3 or 4.

3. The method according to claim 1, wherein at least part of the atoms between the carbonyl group of the first functional group and the carbonyl group of the second functional group of a pair of functional groups of the type —C(═O)ORx and/or of the type —C(═O)— is part of cyclic structure, the cyclic structure optionally being substituted.

4. The method according to claim 1, wherein the at least one compound A has a′ functional groups of the type —C(═O)ORx with each of the a′ functional groups of the type —C(═O)ORx belonging to a pair of functional groups comprising a first functional group and a second functional group.

5. The method according to claim 1, wherein at least part of the atoms between the carbonyl group of the first functional group and the carbonyl group of the second functional group of a pair of functional groups of the type-C(═O)ORx comprises a linear saturated or unsaturated hydrocarbon, optionally one of the atoms between the carbonyl group of the first functional group and the carbonyl group of the second functional group being substituted.

6. The method according to claim 1, wherein the first primary amine functional group and the second primary amine functional group of a pair of b′ primary amine functional groups are linked by a clinking moiety comprising or consisting of a group selected from the group consisting of C₆₋₄₀alkyl, C₆₋₂₄alkenyl, C₆₋₄₀alkynyl, C₆₋₂₄aryl, C₆₋₂₄cycloalkyl, C₆₋₂₄arylC₁₋₄₀alkyl; wherein one or more of the carbon atoms in the backbone of the alkyl, alkenyl, alkynyl, aryl or cycloalkyl may be replaced by a heteroatom independently selected from O, S, N and Si and wherein the alkyl, alkenyl, alkynyl, aryl or cycloalkyl may be unsubstituted or further substituted.

7. The method according to claim 1, wherein the functional group comprising at least one active hydrogen atom and being capable of reacting with an epoxide functional group is selected from the group consisting of primary amine functional groups, secondary amine functional groups, alcohol functional groups, thiol functional groups and —C(═O)OH functional groups.

8. The method according to claim 1, wherein at least one compound E is present in step a), with the at least one compound E comprising e′ primary amine functional and not comprising a pair of b′ primary amine functional group, with e′ being an integer equal or greater than 1, the at least one compound E being present in an amount of maximum 10 wt % of the total amount of the at least one compound B, wherein during step a) dynamic bonds are formed by reaction of at least part of the a′ functional groups of the type —C(═O)ORx and/or of the type —C(═O)— with at least part of the b′ primary amine functional groups of the at least one compound B and optionally by reaction of at least part of the a′ functional groups of the type —C(═O)ORx and/or of the type —C(═O)— with at least part of the e′ primary amine functional groups of the at least one compound E.

9. The method according to claim 1, wherein at least one compound D is present in the mixture of step b), with the at least one compound D having at d′ functional groups having at least one active hydrogen atom capable of reacting with an epoxide functional group, with d′ being an integer equal or greater than 1, the at least one compound D being present in an amount of maximum 10 wt % of the mixture at the start of step b).

10. The method according to claim 1, wherein the functional group comprising at least one active hydrogen atom and being capable of reacting with an epoxide functional group comprises a b′ functional group of the at least one compound B that has not reacted with one of the a′ functional group of the at least one compound A or comprises a b″ additional functional group of the at least one compound B or comprises an e′ functional group of the at least one compound E or comprises a d′ functional group of the at least compound D present in the mixture at the start of step b).

11. A composition comprising an epoxy-derived covalent adaptable network , wherein the epoxy-derived covalent adaptable network comprises
a) at least one compound A in contact with at least one compound B, hereby obtaining a mixture comprising a curing agent,
with the at least one compound A having a′ functional groups of the type —C(═O)ORx and/or of the type —C(═O)—, with a′ being an integer equal or greater than 2 and with Rx for each functional group being independently selected from the group consisting of H and C1-C4 alkyls, with each of the a′ functional groups of the type —C(═O)ORx and/or of the type —C(═O)—belonging to a pair of functional groups comprising a first functional group and a second functional group, whereby the number of atoms between the carbonyl group of the first functional group and the carbonyl group of the second functional group ranges between 2 and 8, and whereby in case the at least one compound A comprises a pair of functional groups having a functional group of the type —(C═O)— as first and as second functional group, the at least one compound A comprises a cyclic carboxylic acid anhydride with the first and the second functional groups belonging to the carboxylic acid functional group of the at least one compound A, and
with the at least one compound B having b′ primary amine functional groups, with b′ being an integer equal or greater than 2, with each of the b′ primary amine functional groups belonging to a pair of functional groups comprising a first primary amine functional group and a second primary amine functional group, whereby the number of atoms between the first primary amine functional group and the second primary amine functional group is at least 5, each of the of b′ primary amine functional groups being directly connected to a primary carbon atom,
wherein during step a) dynamic bonds are formed by reaction of at least part of the a′ functional groups of the type —C(═O)ORx and/or of the type —C(═O)— with at least part of the b′ primary amine functional groups,
b) the mixture of step a) in contact with at least one compound C, hereby obtaining an epoxy-derived covalent adaptable network,
with the at least one compound C having c′ epoxide functional groups, with c′ being an integer equal or greater than 2,
wherein permanent bonds are formed during the contact of the mixture of step b) by reaction of at least part of the least c′ epoxide functional groups with an active hydrogen atom of a functional group capable of reacting with an epoxide functional group present in the mixture,
wherein
Σηⱼb′ⱼ being equal or greater than Σnᵢa′ᵢ
the ratio
$$\frac{\sum {n}_{k} {c}_{k}^{′}}{x}$$
ranging between 0.5 and 1.5, and
the ratio
$$\frac{\sum {n}_{i} {a}_{i}^{′}}{\sum {n}_{i} {a}_{i}^{′} + x}$$
being equal or greater than 0.4 in case x<Σnₖ c′ₖ or the ratio
$$\frac{\sum {n}_{i} {a}_{i}^{′}}{\sum {n}_{i} {a}_{i}^{′} + \sum {n}_{k} {c}_{k}^{′}}$$
being equal or greater than 0.4 in case x<Σnₖc′_{k with}
nᵢ being the number of mmol of compound Aj with functionality a′ᵢ,
nⱼ being the number of mmol of compound Bⱼ with functionality_b′ⱼ,
nₖ being the number of mmol of compound Cᵢ with functionality_c′ₖ,
X being the total number of active hydrogen atoms of all functional groups capable of reacting with an epoxide functional group present at the start of step b).

12. The composition according to claim 11, wherein the number of atoms between the carbonyl group of the first functional group and the carbonyl group of the second functional group of a pair of a′ functional groups of the type —C(═O)ORx and/or of the type —C(═O)—is 2, 3 or 4.

13. The composition according to claim 11, wherein at least part of the atoms between the carbonyl group of the first functional group and the carbonyl group of the second functional group of a pair of functional groups of the type —C(═O)ORx and/or of the type —C(═O)— is part of cyclic structure, the cyclic structure optionally being substituted.

14. The composition according to claim 11, wherein the at least one compound A has a′ functional groups of the type —C(═O)ORx with each of the a′ functional groups of the type —C(═O)ORx belonging to a pair of functional groups comprising a first functional group and a second functional group.

15. The composition according to claim 11, wherein at least part of the atoms between the carbonyl group of the first functional group and the carbonyl group of the second functional group of a pair of functional groups of the type —C(═O)ORx comprises a linear saturated or unsaturated hydrocarbon, optionally one of the atoms between the carbonyl group of the first functional group and the carbonyl group of the second functional group being substituted.

16. The composition according to claim 11, wherein the first primary amine functional group and the second primary amine functional group of a pair of b′ primary amine functional groups are linked by a clinking moiety comprising or consisting of a group selected from the group consisting of C₆₋₄₀alkyl, C₆₋₂₄alkenyl, C₆₋₄₀alkynyl, C₆₋₂₄aryl, C₆₋₂₄cycloalkyl, C₆₋₂₄arylC₁₋₄₀alkyl; wherein one or more of the carbon atoms in the backbone of the alkyl, alkenyl, alkynyl, aryl or cycloalkyl may be replaced by a heteroatom independently selected from O, S, N and Si and wherein the alkyl, alkenyl, alkynyl, aryl or cycloalkyl may be unsubstituted or further substituted.

17. The composition according to claim 11, wherein the functional group comprising at least one active hydrogen atom and being capable of reacting with an epoxide functional group is selected from the group consisting of primary amine functional groups, secondary amine functional groups, alcohol functional groups, thiol functional groups and —C(═O) OH functional groups.

18. The composition according to claim 11, wherein at least one compound E is present in step a), with the at least one compound E comprising e′ primary amine functional and not comprising a pair of b′ primary amine functional group, with e′ being an integer equal or greater than 1, the at least one compound E being present in an amount of maximum 10 wt % of the total amount of the at least one compound B,
wherein during step a) dynamic bonds are formed by reaction of at least part of the a′ functional groups of the type —C(═O)ORx and/or of the type —C(═O)— with at least part of the b′ primary amine functional groups of the at least one compound B and optionally by reaction of at least part of the a′ functional groups of the type —C(═O)ORx and/or of the type —C(═O)— with at least part of the e′ primary amine functional groups of the at least one compound E.

19. The composition according to claim 11, wherein at least one compound D is present in the mixture of step b), with the at least one compound D having at d′ functional groups having at least one active hydrogen atom capable of reacting with an epoxide functional group, with d′ being an integer equal or greater than 1, the at least one compound D being present in an amount of maximum 10 wt % of the mixture at the start of step b).

20. The composition according to claim 11, wherein the functional group comprising at least one active hydrogen atom and being capable of reacting with an epoxide functional group comprises a b′ functional group of the at least one compound B that has not reacted with one of the a′ functional group of the at least one compound A or comprises a b″ additional functional group of the at least one compound B or comprises an e′ functional group of the at least one compound E or comprises a d′ functional group of the at least compound D present in the mixture at the start of step b).
